(19) United States
(12) Patent Application Publication
(10) Pub. No.: US 2009/0193207 A1
(43) Pub. Date: Jul. 30, 2009

(54) Computer system, remote copy method and first computer

(75) Inventors: Youko Ogata, Hiratsuka (JP); Hidenori Suzuki, Hadano (JP)

Correspondence Address: Stanley P.Fisher;Reed Smith LLP, Suite 1400, 3110 Fairview Park Drive, Falls Chruch, VA, 22042-4503, US

(73) Assignee: Hitachi, Ltd.

(21) Appl. No.: 12/076,329

(22) Filed: Mar. 17, 2008

(30) Foreign Application Priority Data
Jan. 29, 2008 (JP) 2008-017449

(51) Int. Cl. G06F 15/167; G06F 12/16

(52) U.S. Cl. 711/162; 709/213; 711/E12.103

(57) ABSTRACT

In a computer system of the present invention, the logical volume of a network storage device can be exclusively shared by a plurality of computers. A first computer, upon receiving a remote copy request, writes a remote copy target file to a logical volume inside a shared storage device, and stores location management information showing the write-destination or the like of the file in a memory device. A second computer, upon receiving an access request, acquires the logical volume lock from the first computer. The second computer mounts the logical volume, and executes the desired processing. Furthermore, the second computer reads out the file from the logical volume based on the location management information.

### CROSS-REFERENCE TO PRIOR APPLICATION

This application relates to and claims the benefit of priority from Japanese Patent Application number 2008-017449, filed on Jan. 29, 2008, the entire disclosure of which is incorporated herein by reference.

### BACKGROUND OF THE INVENTION

1. Field of the Invention

The present invention relates to a computer system, a remote copy method, and a first computer.

2. Description of the Related Art

An iSCSI (Internet Small Computer System Interface), which can make use of SCSI commands utilizing an IP (Internet Protocol) network, has been proposed. In iSCSI technology, an SCSI command, data and so forth are stored in a TCP/IP (Transmission Control Protocol/Internet Protocol) packet and encapsulated. Consequently, a storage device that conforms to iSCSI technology can be directly connected to a communication network, and a computer connected to the communication network can access the storage device to read and write data (JP-A-2005-352844).

Another prior art that is known is not iSCSI-related technology, but rather technology by which a plurality of computers uses a single storage device (JP-A-2005-346426).

When a plurality of computers makes use of one shared storage device installed in a physically remote location, the problem is that access response time deteriorates. For example, due to the communication delay times that occur between the respective computers and the shared storage device, as well as the time required for the respective computers to mount and unmount the shared storage device, response times deteriorate.

For example, when one computer uses a shared storage device, the one computer mounts the shared storage device, inputs and outputs data to and from the shared storage device, and subsequent to the end of processing, unmounts the shared storage device. While the one computer is mounting the shared storage device, the other computer cannot make use of the shared storage device. Similarly, the other computer, after confirming that the one computer has unmounted the shared storage device, mounts the shared storage device, and inputs/outputs data to/from the shared storage device. Subsequent to the end of processing, the other computer unmounts the shared storage device. While the other computer is using the shared storage device, the one computer cannot make use of the shared storage device.

For example, even in the case of a remote copy, which transfers data from the one computer to the other computer, procedures similar to the above are executed. In a remote copy, first, the remote copy-source computer mounts the shared storage device, writes the remote copy target data to the shared storage device, and thereafter unmounts the shared storage device. Next, the remote copy-destination computer mounts the shared storage device, reads out the remote copy target data from the shared storage device, and thereafter unmounts the shared storage device.

Therefore, the larger the amount of remote copy target data, that is, the more times remote copy is carried out, the number of times the respective computers mount and unmount the shared storage device also increases. The processing by which the computer mounts and unmounts the shared storage device constitutes overhead, and deteriorates the response time of the shared storage device. In particular, a lock must be acquired when attempting to mount the shared storage device and this takes time.

However, by caching a portion of the data inside the shared storage device to memories inside the respective computers, it is possible to quickly carry out processing related to the cached data. When updating or deleting the data inside the shared storage device, it becomes necessary to create cache data once again. The process for re-creating the cache data increases response time.

### SUMMARY OF THE INVENTION

With the foregoing in view, an object of the present invention is to provide a computer system, a remote copy method and a first computer, which enable a plurality of computers to share the data inside a shared storage device, while preventing the response performance of the shared storage device from deteriorating. Another object of the present invention is to provide a computer system, a remote copy method and a first computer capable of improving the response performance of the shared storage device by reducing the number of times the shared storage device is mounted. Yet other objects of the present invention should become clear from the descriptions of the embodiments, which will be explained hereinbelow.

A computer system according to a first aspect of the present invention, which solves the above problems, is a computer system in which a first computer, a second computer, and a shared storage device are communicably connected via a communication network, wherein the shared storage device comprises at least one logical volume that is shared by the first computer and the second computer, the first computer comprises a first storage device, and a first controller for respectively controlling input/output of data to/from the first storage device, and permission to use the shared storage device, the second computer comprises a second storage device, and a second controller for controlling the input/output of data to/from the second storage device, the first controller, upon receiving a remote copy request to remote copy data from the first storage device to the second storage device via the logical volume, transfers the remote copy target data specified by the remote copy request from the first storage device and stores the data in the logical volume, and, stores location management information, which shows that the remote copy target data is stored in a prescribed location in the logical volume, in the first storage device, and the second controller queries the first controller in accordance with an inputted access request for permission to use the logical volume, acquires the location management information from the first storage device, and transfers the remote copy target data stored in the logical volume to the second storage device from the logical volume.

In a second aspect according to the first aspect, an access request inputted to the second computer is any one of a request to read from the logical volume, a request to write to the logical volume, a request to check the logical volume, or a request to delete the data inside the logical volume.

In a third aspect according to the first or second aspect, when an access request inputted to the second computer shows that remote copy is prohibited, the second controller does not transfer the remote copy target data from the logical volume to the second storage device.

In a fourth aspect according to any of the first through the third aspects, the second controller, upon receiving permission from the first controller to use the logical volume, accesses the first storage device and determines whether or not location management information is stored in the first storage device, and when the location management information is stored in the first storage device, transfers all the remote copy target data specified by the location management information from the logical volume to the second storage device.

In a fifth aspect according to any of the first through the fourth aspects, the first storage device comprises a first memory device, and a first auxiliary storage device with a storage capacity that is larger than the first memory device, and the location management information is stored in the first memory device.

In a sixth aspect according to any of the first through the fourth aspects, the first controller comprises a cache function for temporarily storing data read out from the logical volume, and the cache function controls the temporary data storage destination in accordance with the type of data read out from the logical volume.

In a seventh aspect according to the sixth aspect, when the data stored in the logical volume is changed, the first controller destroys the cache data corresponding to the data to be changed, and, when the data stored in the logical volume is read out, stores the cache data of the read-out data.

In an eighth aspect according to the seventh aspect, when cache data is created, the first controller creates and stores verification information comprising the location inside the logical volume of the data read out from the logical volume, and the mount point when mounting the data.

In a ninth aspect according to any of the sixth through the eighth aspects, the first storage device comprises a first memory device with a relatively small storage capacity, and a first auxiliary storage device with a relatively larger storage capacity than the first memory device, and the first controller temporarily stores the data read out from the logical volume in the first memory device when the data has a relatively small data size, and stores the data read out from the logical volume in the first auxiliary storage device when the data has a relatively large data size.

In a tenth aspect according to the sixth aspect, the first storage device comprises a first memory device with a relatively small storage capacity, and a first auxiliary storage device with a relatively larger storage capacity than the first memory device, and the first controller, (1) temporarily stores the data read out from the logical volume in the first memory device when the data has a relatively small data size, and stores the data read out from the logical volume in the first auxiliary storage device when the data has a relatively large data size, and furthermore, (2) upon creating the cache data, creates and stores verification information comprising the location inside the logical volume of the data read out from the logical volume, and the mount point when mounting the data, and furthermore, (3) when the data stored in the logical volume is changed, destroys only the cache data corresponding to the data to be changed, and stores the verification information as-is, and, (4) when the data stored in the logical volume is read out, stores the cache data of the read-out data.

In an eleventh aspect according to any of the first through the tenth aspects, the first controller stores a separate usage request issued while the logical volume is used in a wait queue, and when it becomes possible to use the logical volume, issues an indication to reboot the separate usage request stored in the wait queue.

In a twelfth aspect, the shared storage device is configured as a storage device that operates on the basis of the iSCSI (Internet Small Computer System Interface).

A remote copy method according to a thirteenth aspect is a method for carrying out a remote copy from a first computer to a second computer by way of a shared storage device, the shared storage device comprising at least one logical volume that is shared by the first computer and the second computer, in the remote copy method the first computer receives a remote copy request to remote copy data from a first storage device of the first computer to a second storage device via the logical volume, the first computer transfers the remote copy target data specified by the remote copy request from the first storage device and stores the data in the logical volume, the first computer stores location management information, which shows that the remote copy target data is stored in a prescribed location in the logical volume, in the first computer, the second computer receives an access request related to the logical volume, the second computer queries the first computer for permission to use the logical volume, the first computer responds to the query from the second computer, the second computer acquires the location management information from the first computer upon obtaining permission to use the logical volume from the first computer, and the second computer transfers all or a portion of the remote copy target data stored in the logical volume to the second storage device of the second computer from the logical volume.

A first computer according to a fourteenth aspect is a first computer, which is respectively connected to a second computer and a shared storage device via a communication network, the shared storage device comprising at least one logical volume that is shared by the first computer and the second computer, the first computer comprising: a first storage device; and a first controller for respectively controlling input/output of data to/from the first storage device, and the permission to use the shared storage device, wherein the first controller, upon receiving a remote copy request to remote copy data from the first storage device to the second storage device of the second computer via the logical volume, transfers the remote copy target data specified by the remote copy request from the first storage device and stores the data in the logical volume, and, stores location management information, which shows that the remote copy target data is stored in a prescribed location in the logical volume, in the first storage device, and when the second computer queries for permission to use the logical volume, transfers the remote copy target data in the logical volume to the second storage device from the logical volume on the basis of the location management information.

At least a portion of the configuration requirements of the present invention can be generated as a computer program. This computer program, for example, can be affixed to a recording medium, such as a memory or optical disk, or can be distributed by using a communication medium such as a communication network.

### BRIEF DESCRIPTION OF THE DRAWINGS

FIG. 1 is a schematic diagram showing an overview of an embodiment of the present invention;

FIG. 2 is a block diagram showing the entire computer system related to this embodiment;

FIG. 3 is a block diagram showing the configurations of respective servers;

FIG. 4 is a schematic diagram showing an example of management information;

FIG. 5 is a flowchart of a read process executed by a first server;

FIG. 6 is a flowchart showing a cache data storage process;

FIG. 7 is a flowchart of a write process executed by the first server;

FIG. 8 is a flowchart of a read process executed by a second server;

FIG. 9 is a flowchart of a remote copy process;

FIG. 10 is a flowchart of a write process executed by the second server;

FIG. 11 is a flowchart of a check process executed by the second server;

FIG. 12 is a flowchart of a remote copy process executed by the first server;

FIG. 13 is a schematic diagram showing how to create remote copy information;

FIG. 14 is a schematic diagram showing how the second server reads out a remote copy target file;

FIG. 15 is a flowchart of a reprocessing request process;

FIG. 16 is a flowchart of a second server-executed read process related to a second embodiment;

FIG. 17 is a flowchart of a write process executed by the second server;

FIG. 18 is a flowchart of a remote copy process related to a third embodiment;

FIG. 19 is a schematic diagram showing the entire computer system related to a fourth embodiment;

FIG. 20 is a schematic diagram showing the entire computer system related to a fifth embodiment;

FIG. 21 is a schematic diagram showing the configuration of a first computer center;

FIG. 22 is a schematic diagram showing the configuration of a second computer center;

FIG. 23 is a schematic diagram showing how a plurality of computers makes exclusive use of a logical volume of an iSCSI disk;

FIG. 24 is a schematic diagram showing an example of an I/O command;

FIG. 25 is a schematic diagram showing a method for managing cache data;

FIG. 26 is a schematic diagram showing the configuration of a server controller;

FIG. 27 is a flowchart showing I/O command basic processing;

FIG. 28 is a flowchart showing remote copy processing;

FIG. 29 is a schematic diagram showing a portion of a computer system related to a sixth embodiment;

FIG. 30 is a schematic diagram showing another part of the computer system; and

FIG. 31 is a flowchart showing a remote copy method related to a seventh embodiment.

### DESCRIPTION OF THE SPECIFIC EMBODIMENTS

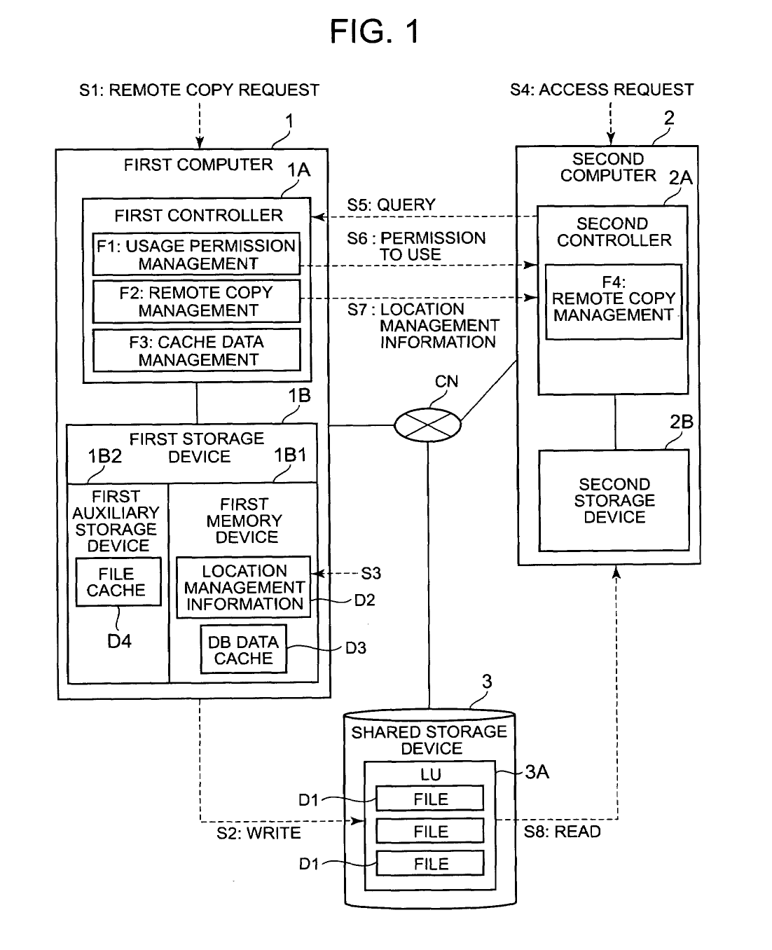

The embodiment of the present invention will be explained hereinbelow on the basis of the attached figures. FIG. 1 is a schematic diagram showing this embodiment in its entirety. FIG. 1 presents an overview of the present invention to the extent necessary to understand and implement the present invention, and the scope of the present invention is not limited to the configuration shown in FIG. 1. The details of this embodiment will be made clear in the embodiments explained hereinbelow.

A computer system related to this embodiment comprises a plurality of computers 1, 2; and at least one shared storage device 3. The respective computers 1, 2 and the shared storage device 3, for example, are respectively arranged in different locations, and are communicably interconnected via a communication network CN. The communication network CN, for example, is configured as a communication network that is capable of using TCP/IP (Transmission Control Protocol/Internet Protocol), such as the Internet. Furthermore, the arrangement of the respective computers 1, 2 and the shared storage device 3 is not limited to that shown in the figure. For example, a variety of arrangements are possible, such as installing the shared storage device 3 at the same location as computer 1, or installing the shared storage device 3 at the same location as computer 2.

The shared storage device 3 will be explained first. The shared storage device 3, for example, is configured as an iSCSI-based storage device. However, the protocol type is not limited to iSCSI. Any protocol that enables a storage device to be directly connected to a wide-area communication network like the Internet can be used.

The shared storage device 3, for example, comprises one or a plurality of storage devices, such as a hard disk drive, optical disk drive, or flash memory device. Furthermore, in this embodiment, no particular distinction is made as to type of storage device. At least one logical volume 3A, which is a physical storage device, is provided by using the physical storage areas of the respective storage drives. The physical storage areas of a plurality of storage drives can be virtualized as a parity group, and one or a plurality of logical volumes 3A can be provided inside the parity group. Or, one or a plurality of logical volumes 3A can also be provided in the physical storage area of one storage drive. A file D1, which is used in common by the respective computers 1, 2, is stored in the logical volume 3A. The logical volume is abbreviated as LU in the figure.

The first computer 1 will be explained. The first computer 1, for example, comprises a first controller 1A, and a first storage device 1B. The first controller 1A is for controlling the operation of the first computer. The first controller 1A, for example, comprises various control functions, such as a usage permission management F1; remote copy management F2; and cache data management F3.

Usage permission management F1 is for managing the logical volume lock inside the shared storage device 3. Lock signifies the authority to make exclusive use of the logical volume 3A. Only the computer having the lock can mount the logical volume 3A. In this embodiment, usage permission management F1 inside the first computer 1 centrally manages the computer system lock.

Remote copy management F2 controls processing when remote copying data from the first computer 1 to the second computer 2 by way of the shared storage device 3. Remote copy target data (hereinafter, will also be called the remote copy target file) D1 is written to the logical volume 3A of the shared storage device 3 by remote copy management F2.

When the second computer 2 accesses the logical volume 3A, the remote copy target file D1, which is stored in the logical volume 3A, is transferred to the second storage device 2B inside the second computer 2, the stored in the second storage device 2B. That is, the transfer of the remote copy target file D1 from the first computer 1 to the logical volume 3A, and the transfer of the remote copy target file D1 from the logical volume 3A to the second computer 2 are carried out asynchronously.

Cache data management F3 controls processing for saving to the first storage device 1B at least a portion of the data stored in the logical volume 3A as cache data. The first storage device 1B, for example, comprises a first memory device 1B1; and a first auxiliary storage device 1B2.

The first memory device 1B1 is a storage device with a relatively small storage capacity. The first auxiliary storage device 1B2 is a storage device with a relatively large storage capacity. The first memory device 1B1, for example, is configured as a semiconductor memory device. The first auxiliary storage device 1B2, for example, is configured as a hard disk device or a flash memory device. However, no particular distinction is made as to storage device type.

Cache data management F3 controls the storage destination thereof in accordance with the type of cache-targeted data. File data with a relatively large data size is stored in the first auxiliary storage device 1B2, and DB (Database) data with a relatively small data size is stored in the first memory device 1B1.

The second computer 2 will be explained. The second computer 2, for example, comprises a second controller 2A; and a second storage device 2B. The second controller 2A is for controlling the operation of the second computer 2, and executes remote copy management F2. The second storage device 2B stores a file and DB data. The second computer 2 accesses the logical volume 3A based on an access request from a host computer, and executes the requested processing.

The flow of operations in accordance with this embodiment will be explained. The first computer 1, for example, receives a remote copy request from a host computer or the like not shown in the figure (S1). The remote copy request comprises information (for example, an absolute path) for specifying a remote copy target file D1, and information related to the copy destination of the specified file D1.

Remote copy management F2 queries usage permission management F1 regarding the use of the logical volume 3A. When usage permission management F1 allows the use of the logical volume 3A, the first computer 1 mounts the logical volume 3A to the first computer 1.

Remote copy management F2 writes the remote copy target file D1 to the logical volume 3A (S2). Remote copy management F2 saves location management information D2 related to the file D1 written to the logical volume 3A to the first memory device 1B1 (S3). The location management information D2, for example, comprises information related to the filename and storage location of the remote copy target file D1.

When the file D1 has been written to the logical volume 3A, the first computer 1 unmounts the logical volume 3A. Usage permission management F1 confirms that the logical volume 3A has been unmounted from the first computer 1.

When the second computer 2 receives an access request from the host computer (S4), the second controller 2A queries usage permission management F1 in the first controller 1A regarding the use of the logical volume 3A (S5). When the logical volume 3A is not mounted to the first computer 1, usage permission management F1 allows the use of the logical volume 3A by the second computer 2 (S6).

The second computer 2, which has acquired the logical volume 3A-related lock, mounts the logical volume 3A. The second controller 2A, subsequent to the logical volume 3A being mounted to the second computer 2, acquires the location management information D2 stored in the first memory device 1B1 (S7).

For example, the first computer 1 determines whether or not the location management information D2 related to the logical volume 3A mounted to the second computer 2 is stored in the first memory device 1B1, and when the information D2 is stored in the first memory device 1B1, sends the location management information D2 to the second computer 2.

Remote copy management F4 of the second computer 2 read out the remote copy target file D1 from the logical volume 3A, and stores the file D1 in the second storage device 2B on the basis of the location management information D2 (S8). Consequently, the remote copy from the first computer 1 to the second computer 2 is completed.

Next, the management of the cache data will be explained. When data is read out from the logical volume 3A, cache data management F3 stores the cache data in either one of the first memory device 1B1 or the first auxiliary storage device 1B2 in accordance with the type of the data. In the case of file data, the cache data D4 is stored in the first auxiliary storage device 1B2. For small size data like DB data, the cache data D3 is stored in the first memory device 1B1.

As will become clear from the embodiments explained hereinbelow, when cache data management F3 creates the cache data D3, D4, cache data management F3 at the same time also creates mount verification data. Mount verification data is used when mounting the logical volume 3A. Further, mount verification data can also be used to process a test command.

When data is read out from the logical volume 3A, but cache data has not been created for the data, cache data management F3 creates cache data related to the data.

When the data inside the logical volume 3A is to be changed, cache data management F3 destroys the cache data corresponding to the change-targeted data. Data changes, for example, can include an update, addition, deletion, filename change, and the like. Destroying the cache data signifies that the cache data can no longer be used.

In this embodiment, which is configured thusly, usage permission management F1 inside the first computer 1 centrally manages the use of the logical volume 3A. Therefore, it is possible for a plurality of computers 1, 2 to share a remotely located shared storage device 3.

In this embodiment, the first computer 1, subsequent to writing the remote copy target file D1 to the logical volume 3A inside the shared storage device 3, stores the location management information D2 in the first memory device 1B1. When the second computer 2 accesses the logical volume 3A, the second computer 2 either passively or actively acquires the location management information D2. The second computer 2 reads out the remote copy target file D1 stored in the logical volume 3A, and stores the file D1 in the second storage device 2B on the basis of the location management information D2.

That is, in this embodiment, a remote copy target file is not transferred from the logical volume 3A to the second computer 2 each time there is a remote copy. In this embodiment, remote copy target files D1 are accumulated in the logical volume 3A, and the second computer 2 takes advantage of an opportunity to use the logical volume 3A to transfer remote copy target files accumulated in the logical volume 3A to the second storage device 2B.

The second computer 2, in addition to inputting/outputting data to/from the logical volume 3A based on an access request (S4), reads out a remote copy target file D1 accumulated in the logical volume 3A, and stores the file D1 in the second storage device 2B.

Thus, in this embodiment, the second computer 2 does not mount the logical volume 3A simply to read out a remote copy target file D1, but rather reads out a remote copy target file D1 while processing a different access request. Therefore, it is possible to reduce the number of times the second computer 2 mounts the logical volume 3A, thereby making it possible to enhance the response performance of the shared storage device 3.

In this embodiment, file data that has a large data size is stored as cache data in the first auxiliary storage device 1B2, and data that has a small data size is stored as cache data in the first memory device 1B1, respectively. Therefore, the first memory device 1B1 will not be fully used up by large-size file data, thereby enhancing usability.

In this embodiment, cache data D3, D4 is created when data is read out from the logical volume 3A, and the cache data D3, D4 is destroyed when the data inside the logical volume 3A changes. In other words, cache data is not created when the data inside the logical volume 3A is updated or otherwise revised, but rather the cache data is created subsequent thereto when the updated or revised data is read out. Cache data is prepared for when the same data is read in a plurality of times, and is used to shorten the read-in time. In this embodiment, when data is actually read in, cache data is created in preparation for consecutive read-ins. Therefore, cache data can be created without waste. This embodiment will be explained in detail hereinbelow.

### First Embodiment

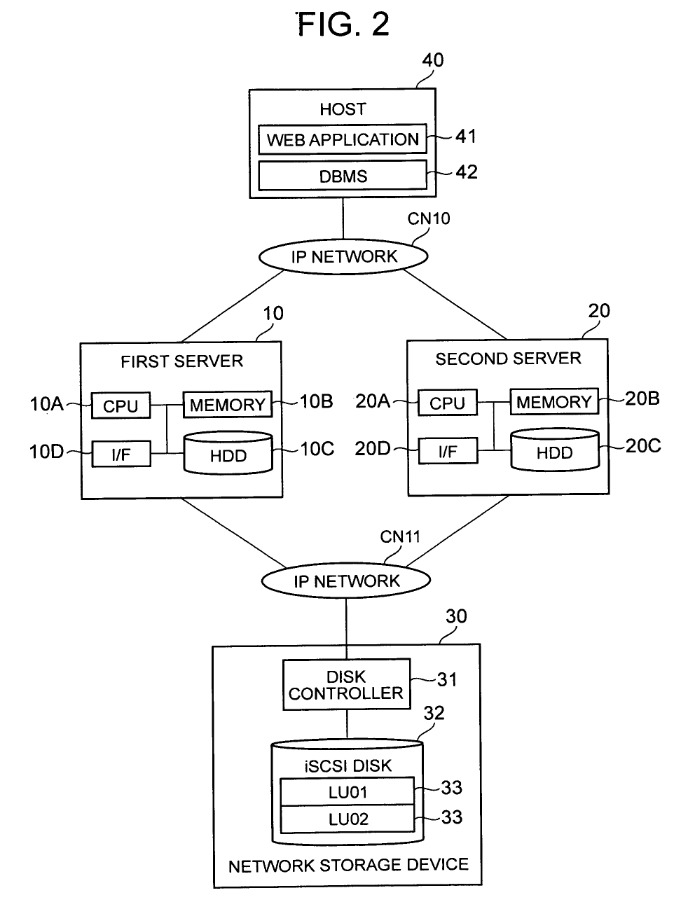

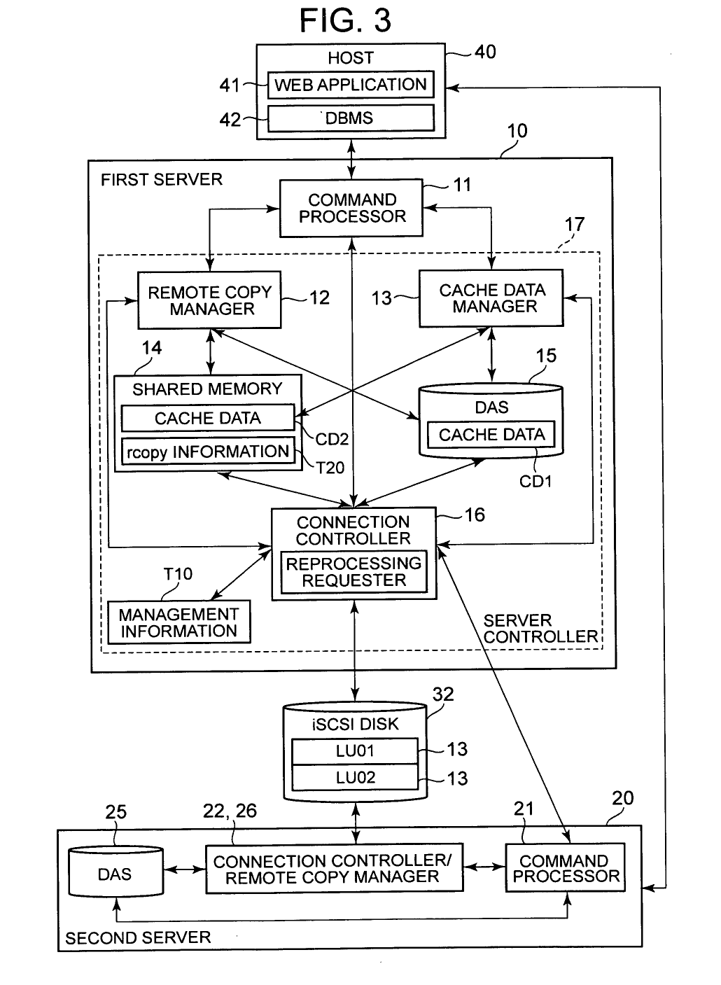

FIG. 2 is a schematic diagram showing the overall configuration of a computer system related to this embodiment. The corresponding relationship with FIG. 1 will be explained first. A first server 10 corresponds to the first computer 1 of FIG. 1, a second server 20 corresponds to the second computer 2 of FIG. 1, a network storage device 30 corresponds to the shared storage device 3 of FIG. 1, communication networks CN10 and CN11 correspond to the communication network CN of FIG. 1, and a logical volume 33 corresponds to the logical volume 3A of FIG. 1. A connection controller 16 in FIG. 3 corresponds to the usage permission function F1 of FIG. 1, a remote copy manager 12 in FIG. 3 corresponds to remote copy management F2 of FIG. 1, and a cache data manager 13 in FIG. 3 corresponds to cache data management F3 of FIG. 1. A remote copy manager 22 in FIG. 3 corresponds to remote copy management F4 of FIG. 1, a DAS 15 in FIG. 3 corresponds to the first auxiliary storage device 1B2 of FIG. 1, a shared memory 14 in FIG. 3 corresponds to the first memory device 1B1 of FIG. 1, and a DAS 25 in FIG. 3 corresponds to the second storage device 2B of FIG. 1.

The computer system, for example, comprises at least one first server 10; at least one second server 20; at least one network storage device 30; and at least one host computer (hereinafter, host) 40.

The host 40 and the respective servers 10, 20 are communicably interconnected via the communication network CN10. The respective servers 10, 20 and the network storage device 30 are communicably interconnected via communication network CN11. FIG. 2 shows separate communication networks, but CN10 and CN11 can also be the same network.

The network storage device 30 is a storage device, which corresponds to iSCSI. The network storage device 30, for example, comprises a disk controller 31; and an iSCSI disk 32. A plurality of iSCSI disks 32 can be provided, but for convenience sake, only one is shown. One or a plurality of logical volumes 33 can be provided in the iSCSI disk 32.

The first server 10, for example, comprises a central processing unit (CPU) 10A; a memory 10B; an auxiliary storage device 10C; and various interface circuits 10D. The memory 10B comprises a shared memory 14, which will be explained hereinbelow. The auxiliary storage device 10C comprises a DAS 15, which will be explained hereinbelow. Similar to the first server 10, the second server 20 also comprises a central processing unit 20A; a memory 20B; an auxiliary storage device 20C; and various interface circuits 20D. The auxiliary storage device 20C comprises a DAS 25, which will be explained hereinbelow. DAS is the abbreviation for Direct Attached Storage. Furthermore, the storage devices of the servers 10, 20 are not limited to DAS.

The host 40, for example, comprises various application programs, such as a web application 41, and a database management system 42 (DBMS 42). These application programs 41, 42 input and output desired data by accessing the first server 10 or the second server 20.

FIG. 3 is a block diagram schematically showing the configuration of the computer system's functions. The first server 10, for example, comprises a command processor 11; remote copy manager 12; cache data manager 13; shared memory 14; DAS 15; connection controller 16; and management information T10. A server controller 17, for example, comprises the remote copy manager 12, cache data manager 13, shared memory 14, DAS 15, connection controller 16, and management information T10.

The command processor 11, for example, receives and processes various commands, such as a write or read command, and sends the result of the processing to the host 40. The remote copy manager 12 controls a remote copy. The cache data manager 13 manages the creation and destruction of cache data.

The shared memory 14 is shared by a plurality of processors inside the first server 10. Furthermore, the second server 20 can also be configured to enable direct access to the shared memory 14. The shared memory 14 stores cache data CD2 used by the DBMS 42, and remote copy information T20. The remote copy information T20 corresponds to “location management information”. The remote copy information T20 will be explained in detail hereinbelow.

The DAS 15, for example, is configured as a hard disk drive or a flash memory device. The DAS 15, for example stores cache data CD1, which is used by the web application 41.

The connection controller 16 controls the connection to the iSCSI disk 32. The connection controller 16 uses the management information T10 to centrally manage the lock necessary for mounting the iSCSI disk 32. The management information T10 will be explained hereinbelow.

The second server 20, similar to the first server 10, for example, comprises a command processor 21; a remote copy manager 22; a DAS 25; and a connection controller 26. In this embodiment, the first server 10 manages permission to use the iSCSI disk 32, and the second server 20 reads out a remote copy target file based on the remote copy information T20 acquired from the shared memory 14. The first server 10 and the second server 20 differ in this respect.

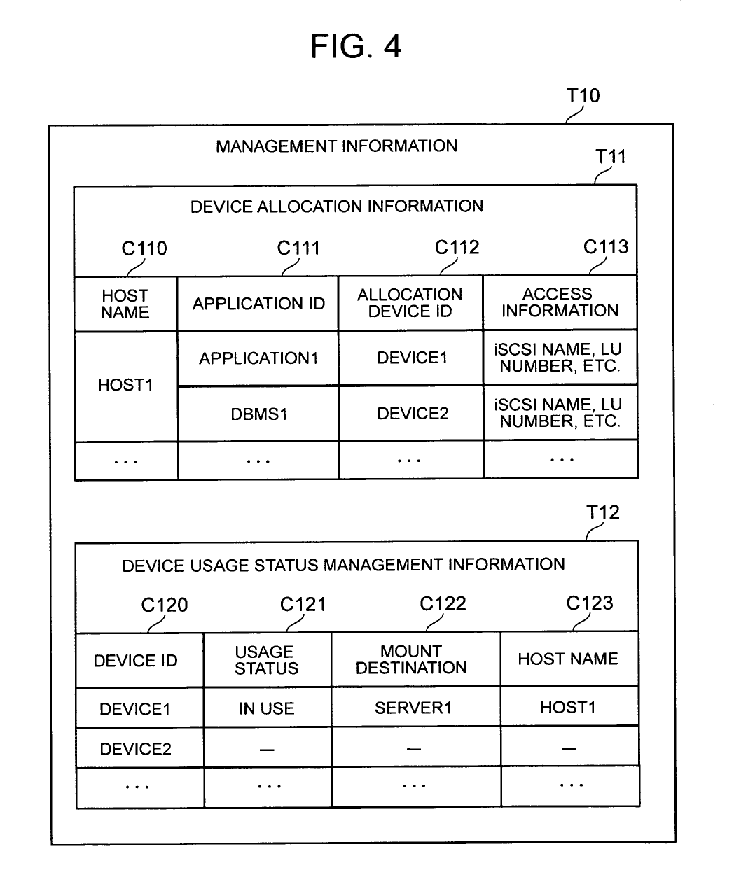

FIG. 4 is a schematic diagram showing an example of the management information T10. The management information T10, for example, comprises device allocation management information T11; and device usage status management information T12. The device allocation management information T11 is information for managing which device is allocated to which application program of which host 40. Simply stated, device signifies the DAS 15 and the iSCSI disk 32. In other words, the device allocation management information T11 manages which application program uses the DAS 15 or the iSCSI disk 32.

The device allocation management information T11, for example, correspondently manages a host name C110; application ID C111; allocation device ID C112; and access information C113. The host name C110 is information for identifying the host 40. Any information that enables the host 40 to be identified is fine, and, for example, an IP address can be used.

The application ID C111 is information for identifying an application program 41, 42. The allocation device ID C112 is information for identifying the device (the DAS or the iSCSI disk), which is allocated to an application program. The access information C113 is information required for accessing the allocated device, and, for example, can comprise an iSCSI name, IP address, or logical volume number.

The device usage status management information T12 is information for managing the usage status of the iSCSI disk 32. The device usage status management information T12, for example, correspondently manages a device ID C120; usage status C121; mount destination C122; and host name C123.

The device ID C120 is information for identifying the iSCSI disk 32. The usage status C121 is information showing whether or not the iSCSI disk 32 is used. The mount destination C122 is information specifying the server to which the iSCSI disk 32 is mounted. The host name C123 is information specifying the host 40, which is using the iSCSI disk 32.

Furthermore, the configurations of the device allocation management information T11 and the device usage status management information T12 are not limited to the above-cited examples. The information T11, T12 can also manage items other than the above-described columns. At the least, the information T11, T12 should be able to manage which device is allocated to an application program, and to which server the iSCSI disk 32 is mounted.

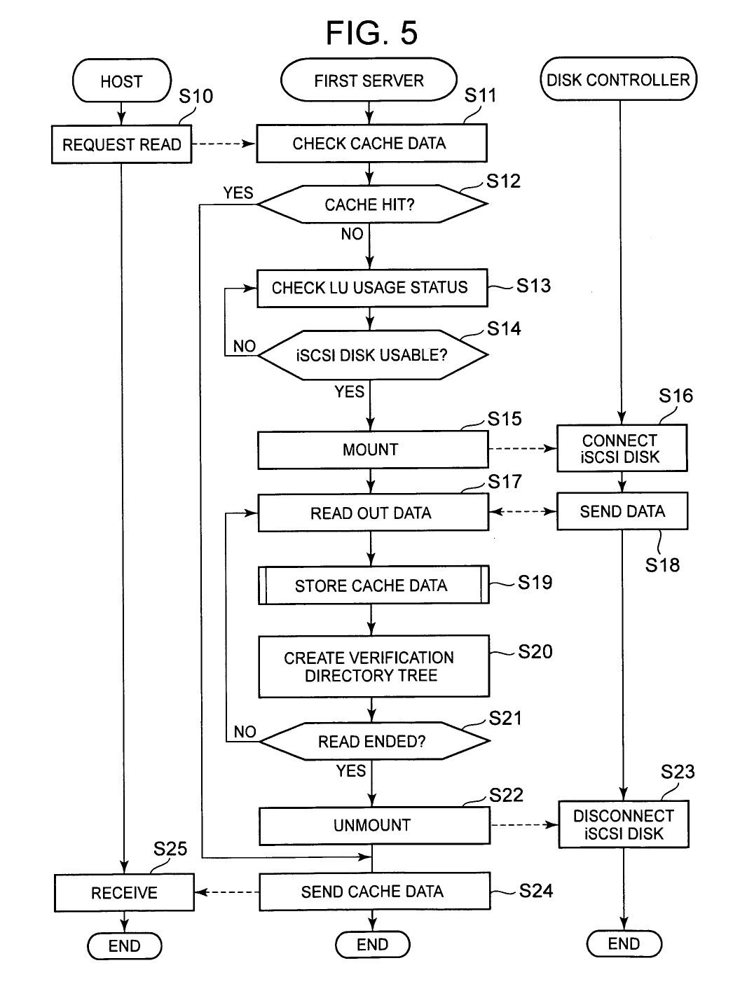

FIG. 5 is a flowchart showing an overview of read processing carried out by the first server 10. The following explanation cites an example, which primarily uses data stored in the logical volume 33 inside the iSCSI disk 32.

Furthermore, the respective flowcharts presented hereinbelow show overviews of processing to the extent needed to understand and implement the present invention, and the processing may differ from that of an actual computer program. Further, a so-called person having ordinary skill in the art should be able to change or delete a step shown in the figure, or add a new step.

The host 40 issues a read request to the first server 10 based on an indication from an application program (S10). The first server 10, upon receiving the read request, checks if there is cache data (S11). The first server 10 determines whether or not the cache data for the requested data exists (S12). In the case of a cache hit, that is, when the data requested from the host 40 is stored in the shared memory 14 or the DAS 15 (S12: YES), the first server 10 sends the cache data to the host 40 (S24). The host 40 receives the cache data sent from the first server 10 (S25).

When the host 40-requested data does not exist inside the first server 10, that is, in the case of a cache miss (S12: NO), the first server 10 has to read out the data from the logical volume 33 of the iSCSI disk 32. Accordingly, the first server 10 checks the usage status of the logical volume 33 in which the requested data is stored (S13), and determines whether or not the logical volume 33 can be used (S14).

When the logical volume 33 is not mounted to either server, the logical volume 33 is able to be used (S14: YES). When the logical volume 33 is used, the first server 10 stands by until the logical volume 33 is unmounted and able to be used (S14: NO).

When the first server 10 determines that the logical volume 33 can be used (S14: YES), the first server 10 acquires the lock for the logical volume 33, and mounts the logical volume 33 (S15). The disk controller 31 connects the iSCSI disk 32 to the first server 10 in accordance with the mount request (S16).

The first server 10 reads out the host 40-requested data from the logical volume 33 (S17, S18), and stores the cache data (S19). In the case of file data, the cache data is stored in the DAS 15, and in the case of DB (database) data, the data is stored in the shared memory 14.

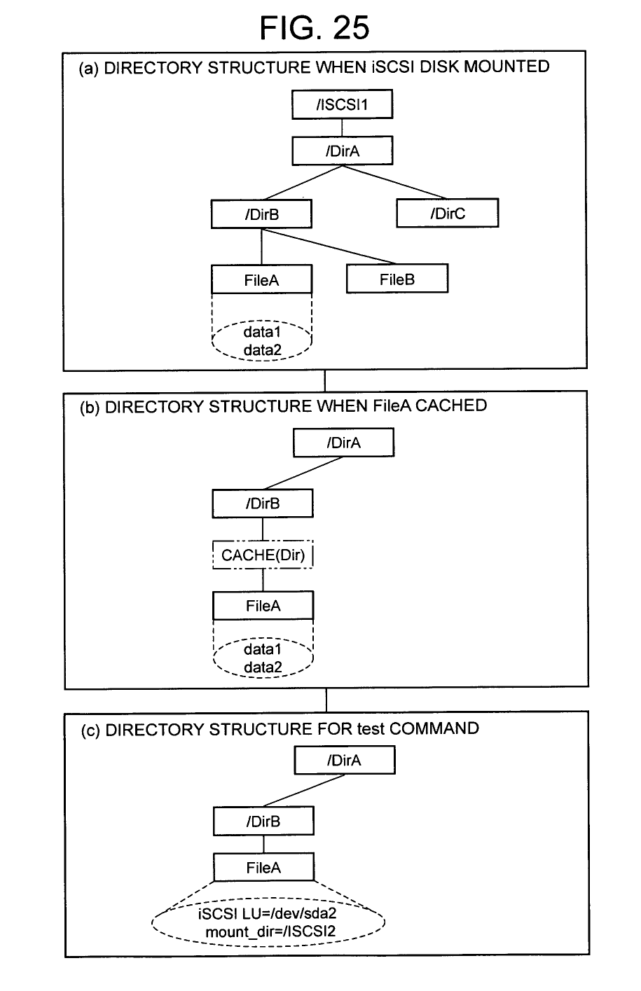

Furthermore, the first server 10 creates and stores a verification directory tree as mount verification information (S20). The first server 10 repeats steps S17 through S20 until all the data requested by the host 40 has been read out from the logical volume 33 (S21: NO). An example of a verification directory tree will be explained using FIG. 25. Furthermore, a configuration that does not create a verification directory tree is also included within the scope of the present invention.

When all the data requested by the host 40 has been read out from the logical volume 33 (S21: YES), the first server 10 unmounts the logical volume 33 (S22, S23). The first server 10 sends the data read out from the logical volume 33 to the host 40 (S24), and the host 40 receives the data (S25).

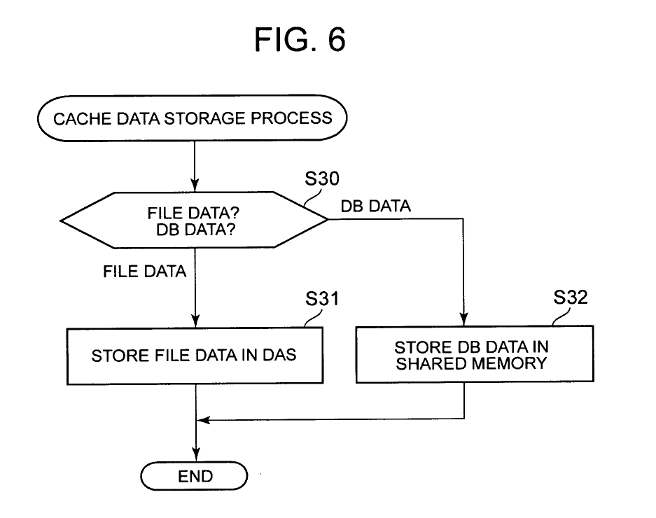

FIG. 6 is a flowchart of the cache data storage processing shown in S19 of FIG. 5. The first server 10 determines if the data read out from the logical volume 33 is file data or DB data (S30). In the case of file data, the first server 10 stores the file data in the DAS 15 (S31). In the case of DB data, the first server 10 stores the DB data in the shared memory 14 (S32).

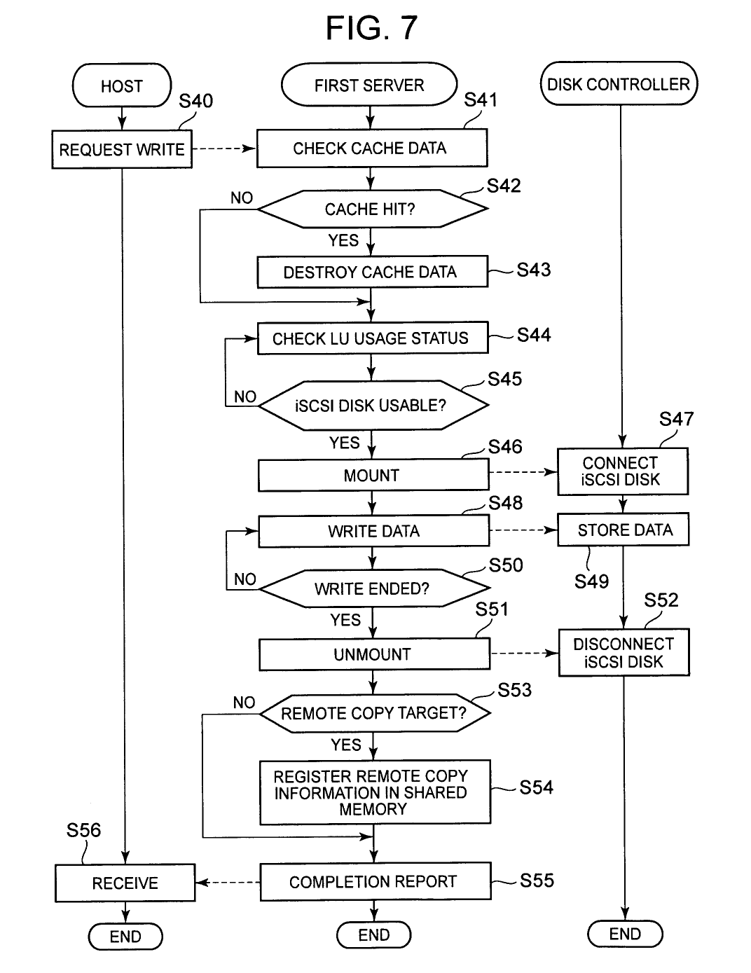

FIG. 7 is a flowchart of a write process executed by the first server. The host 40 issues a write request based on an indication from the application program 41, 42 (S40).

The first server 10, upon receiving the write request, determines whether or not cache data corresponding to the write request exists (S41). When there is a cache hit (S42: YES), the first server 10 destroys the cache data corresponding to the write request (S43).

This is because the data inside the logical volume 33 will change (be updated, revised, add to, deleted, and so forth), making the contents of the cache data obsolete and therefore unusable subsequent to the write.

The first server 10 checks whether or not the logical volume 33 can be used (S44), and when the determination is that the iSCSI disk is capable of being used (S45: YES), mounts the logical volume 33 (S46, S47).

Furthermore, an example in which the cache data is destroyed prior to the first server 10 mounting the logical volume 33 has been described, but instead the configuration can be such that the cache data is destroyed subsequent to the first server 10 mounting the logical volume 33.

The first server 10 writes the write-data received from the host 40 to the logical volume 33, and stores the data in the logical volume 33 (S48, S49). When the write is complete (S50: YES), the first server 10 unmounts the logical volume 33 (S51, S52).

Next, the first server 10 determines whether or not the data written in S48 is the target of a remote copy (S53). For example, the user can issue an indication beforehand so that a remote copy is run when the contents of a prescribed file are updated.

When the data written to the logical volume 33 is the target of a remote copy (S53: YES), the first server 10 creates remote copy information, and stores the remote copy information in a prescribed location of the shared memory 14 (S54). When the data written to the logical volume 33 is not the target of a remote copy (S53: NO), the first server 10 skips step S54, and reports to the host 40 to the effect that write request processing has been completed (S55). The host 40 receives the completion report (S56).

A situation in which the first server 10 reports processing complete to the host 40 subsequent to writing the write-data to the logical volume 33 was described, but instead the configuration can be such that the completion of processing is reported at the point in time that the write-data is received from the host 40.

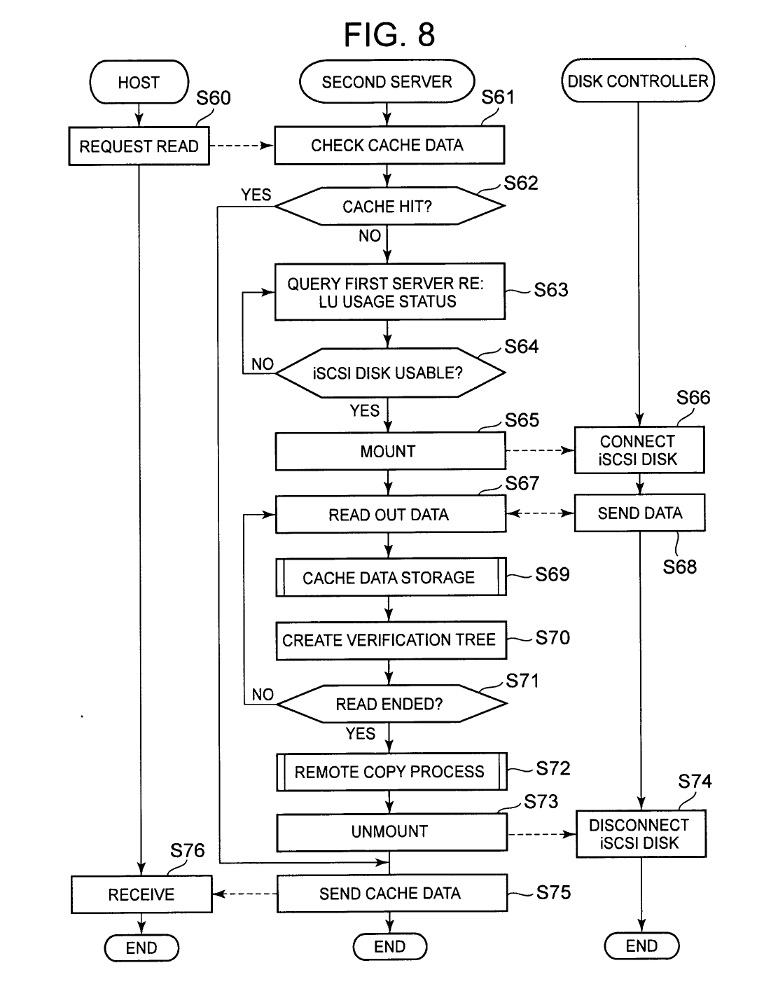

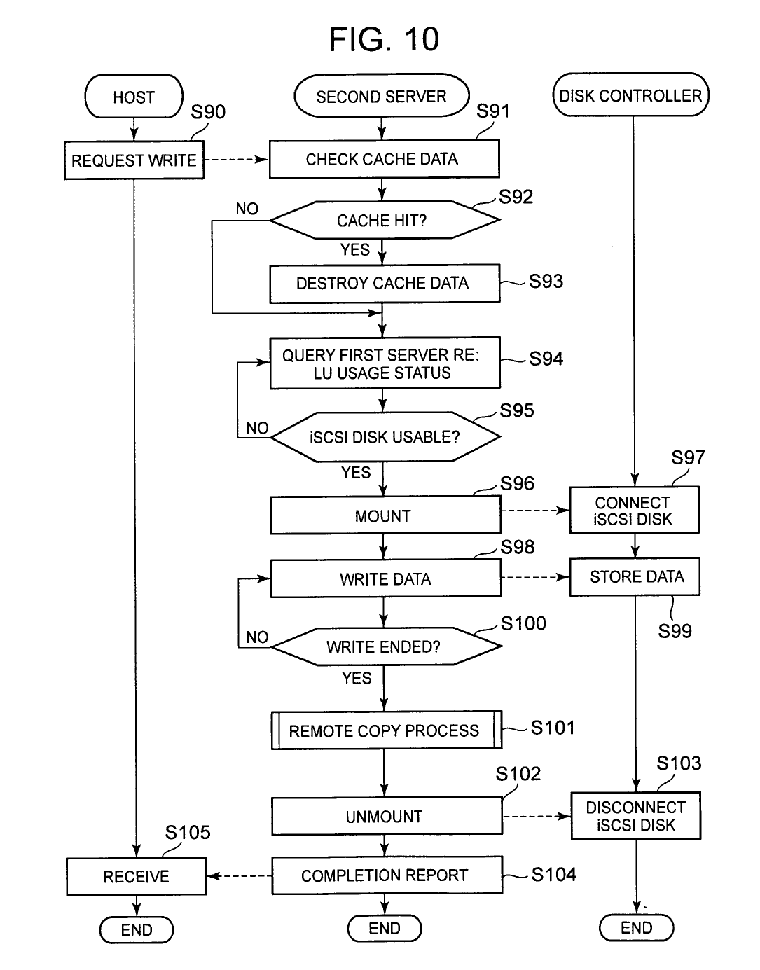

FIG. 8 is a flowchart of a read process executed by the second server 20. The second server 20 can receive a read or write request from the host 40 (refer to FIG. 10).

When the host 40 issues a read request (S60), the second server 20 checks for cache data inside the second server 20 (S61), and determines whether or not cache data corresponding to the read request exists (S62).

In the case of a cache hit (S62: YES), the second server 20 sends the cache data to the host 40 (S75). In the case of a cache miss (S62: NO), the second server 20 queries the first server 10 about the usage status of the logical volume 33 (S63), and determines whether or not it is possible to use the iSCSI disk 32 (S64). In other words, the second server 20 determines whether or not it is possible to acquire the logical volume 33 lock (S64).

When it is possible to use the logical volume 33 (S64: YES), the second server 20 mounts the logical volume 33 (S65, S66). The second server 20 reads out the data requested by the host from the logical volume 33 (S67, S68). The second server 20 can store the data read out from the logical volume 33 in the memory or DAS 25 inside the second server 20 (S69). Since the details of step S69 are the same as the flowchart shown in FIG. 6, a detailed explanation of this step will be omitted. Furthermore, the second server 20 creates a verification directory tree (S70). As stated with regard to FIG. 5, an example of a verification directory tree will be explained hereinbelow.

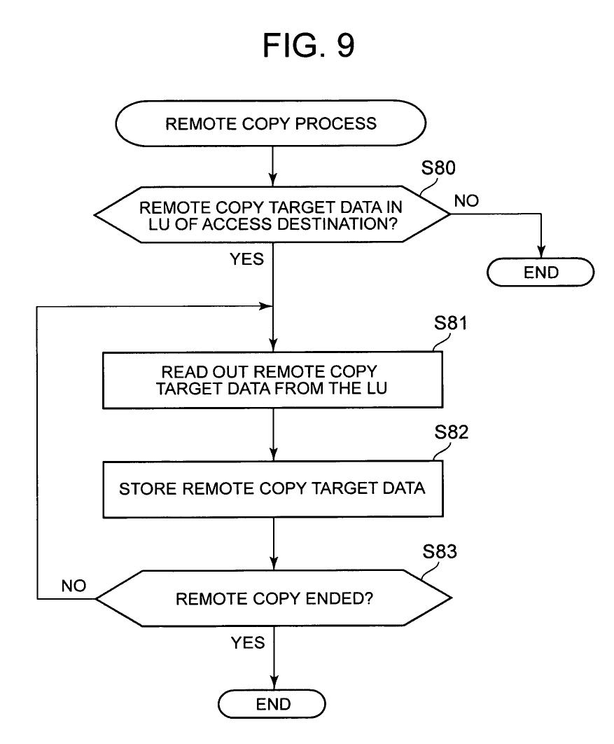

The second server 20 determines whether or not the read-out of all the data requested by the host 40 has been completed (S71). When the read-out of all the requested data has not been completed (S71: NO), the second server 20 returns to S67. When the read-out of all the requested data has been completed (S71: YES), the second server 20 executes the remote copy process (S72). An example of the remote copy process will be explained hereinbelow using FIG. 9.

The second server 20 unmounts the logical volume 33 when read processing (S67 through S71) and remote copy processing (S72) have been completed (S73, S74). The second server 20 reports to the first server 10 to the effect that the logical volume 33 has been unmounted (S73). This is because, in this embodiment, the first server 10 centrally manages permission to use the iSCSI disk 32.

The second server 20 sends the data read out from the logical volume 33 to the host 40 (S75, S76).

FIG. 9 is a flowchart of the remote copy process shown in S72 of FIG. 8. The second server 20 refers to the remote copy information T20 stored in the shared memory 14 inside the first server 10.

For example, the first server 10 determines based on the remote copy information T20 whether or not the remote copy target data (remote copy target file) exists inside the logical volume 33 mounted to the second server 20. When the remote copy target data exists inside the logical volume 33 to be used by the second server 20, the first server 10 can notify the second server 20 of the information related to the remote copy target data comprised in the logical volume 33.

Consequently, the second server 20 knows based on the remote copy information T20 that the remote copy target data (remote copy target file) is stored inside the logical volume 33 (S80).

When the remote copy target file exists inside the logical volume 33 that the second server 20 is using (S80: YES), the second server 20 reads out the remote copy target file from the logical volume 33 (S81). The second server 20 writes the remote copy target file read out from the logical volume 33 to a prescribed location inside the DAS 25 (S82).

The second server 20 repeats steps S81 and S82 until all the remote copy target files stored inside the logical volume 33 have been moved to the DAS 25 (S83).

Thus, when the second server 20 reads out the data from the logical volume 33, the remote copy target file stored in the logical volume 33 is also read out and stored in the DAS 25. No distinction is made as to whether there is a direct or indirect relationship between the read command that the second server 20 receives from the host 40 and the remote copy process for the logical volume 33 related to the read command.

Furthermore, in this embodiment, an explanation was given of a situation in which the first server 10 determines if there is remote copy target data related to the logical volume 33 mounted to the second server 20, and notifies the second server 20 of the result of the determination.

Instead, the configuration can be such that the remote copy information T20 is stored in memory device accessible by both the first server 10 and the second server 20. The configuration can also be such that only the first server 10 can write the remote copy information T20 to the memory device, and the second server 20 can read out the remote copy information T20 from the memory device to the extent required by the second server 20.

FIG. 10 is a flowchart of a write process executed by the second server 20. The second server 20, upon receiving a write request from the host 40 (S90), checks to see if there is cache data (S91).

In the case of a cache hit (S92: YES), the second server 20 destroys the cache data the same as for the first server 10 write process (S93). The second server 20 queries the first server 10 for permission to use the logical volume (S94), and determines whether or not the logical volume 33 lock has been acquired (S95).

When it was possible to acquire the lock for the write-targeted logical volume 33 (S95: YES), the second server 20 mounts the logical volume 33 (S96, S97), and writes the write-data to the logical volume 33 (S98, S99).

The second server 20, upon completing write processing (S100: YES), executes a remote copy process related to the logical volume 33 (S101). An example of remote copy processing is as described using FIG. 9.

When write processing (S98 through S100) and remote copy processing (S101) have been completed, the second server 20 unmounts the logical volume 33 (S102, S103), and reports to the host 40 to the effect that write processing has been completed (S104, S105).

Thus, in the case of a write process as well, remote copy processing (S101) is executed for a remote copy target file stored inside the logical volume 33 related to the write process.

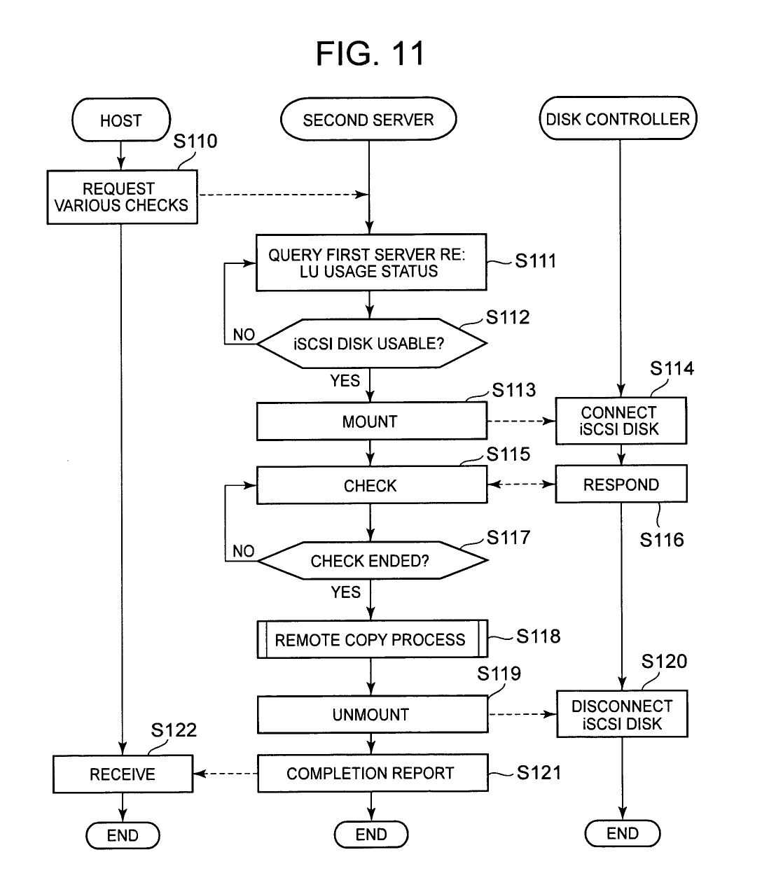

FIG. 11 is a flowchart of a check process executed by the second server 20. A check process, for example, can include a check as to whether or not the logical volume 33 exists, and a query as to volume size.

When the host 40 issues a check command (S110), the second server 20 queries the first server 10 for permission to use the logical volume 33 (S111), and determines whether or not it was possible to acquire the logical volume 33 lock (S112).

When the lock has been acquired (S112: YES), the second server 20 mounts the logical volume 33 (S113, S114), and carries out processing on the basis of the check command (S115, S116).

The second server 20, upon completing the check (S117: YES), executes a remote copy process for the mounted logical volume 33 (S118). When remote copy processing has been completed, the second server 20 unmounts the logical volume 33 (S119, S120). The second server 20 notifies the first server 10 to the effect that the logical volume 33 has been unmounted (S119). The second server 20 reports the completion of check command processing to the host 40 (S121, S122).

Thus, when the logical volume 33 is mounted for the execution of various check commands, remote copy processing related to the logical volume 33 is carried out.

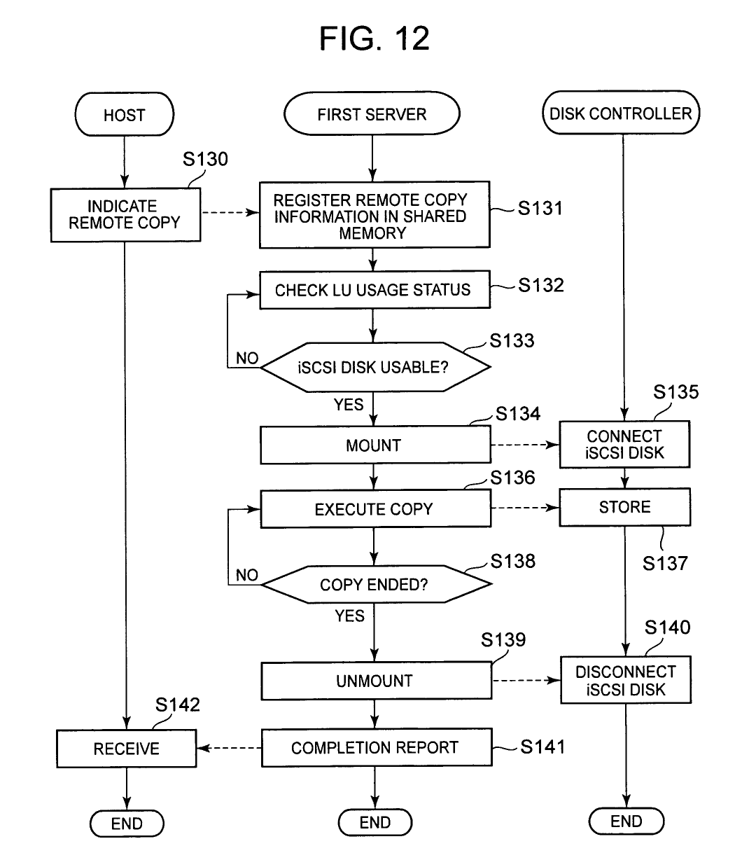

FIG. 12 is a flowchart showing a process related to a remote copy executed by the first server 10.

In FIG. 7, an explanation was given of a situation in which, when a write command was received from the host 40, a determination was made as to whether or not the write-targeted data is a remote copy target, and when the write-targeted data is a remote copy target, remote copy information was registered in the shared memory 14. Instead of this, in the flowchart of FIG. 12, the remote copy information is registered in the shared memory 14 in accordance with a remote copy command issued by the host 40.

The first server 10, upon receiving the remote copy command from the host 40 (S130), creates remote copy information, and registers the remote copy information in the shared memory 14 (S131). Furthermore, the first server 10 can execute S131 subsequent to step S138, which will be explained hereinbelow. In other words, the configuration can be such that the remote copy information is registered in the shared memory 14 subsequent to the remote copy target file being copied to the logical volume 33.

The first server 10 determines whether or not the logical volume 33 specified by the host 40 can be used (S132), and when the logical volume 33 lock has been acquired (S133: YES), the first server 10 mounts the logical volume 33 (S134, S135).

Next, the first server 10 copies the remote copy target file that is inside the DAS 15 to the logical volume 33 (S136), and stores the file in the logical volume 33 (S137).

When the copy to the logical volume has been completed (S138: YES), the first server 10 unmounts the logical volume 33 (S139, S140), and reports to the host 40 to the effect that processing has been completed (S141, S142).

At the point in time of step S141, the remote copy target file is simply stored in the logical volume 33, and remote copy processing has not actually been completed. However, the first server 10 can notify the host 40 that processing is complete.

Thereafter, when the second server 20 mounts the logical volume 33 in accordance with an indication (for example, a write command, read command, check command, or the like) from the host 40, the remote copy target file stored in the logical volume 33 is moved to the second server.

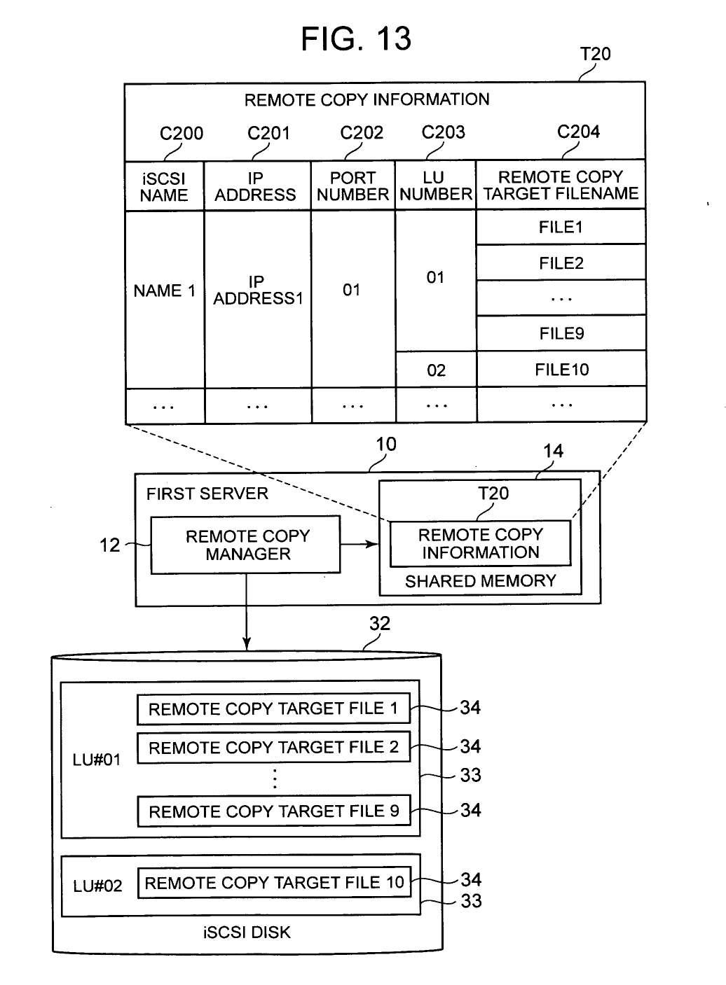

FIG. 13 is a diagram schematically showing how the first server 10 stores a remote copy target file 34 in the logical volume 33, and registers the remote copy information T20 in the shared memory 14.

The configuration of the remote copy information T20 will be explained first. The remote copy information T20 is information showing where inside the logical volume 33 the remote copy target file 34 is stored. The remote copy information T20, for example, correspondently manages the iSCSI name C200, IP address C201, port number C202, logical volume number C203, and remote copy target file name C204. The remote copy target file name C204, for example, is configured as an absolute path. Furthermore, the configuration can also be such that the remote copy information manages an item other than the items described above, or the configuration can be such that a portion of the above-described items is eliminated.

The first server 10, as described above, for example, copies the remote copy target file 34 from the DAS 15 to the logical volume 33 upon receiving a write request or a remote copy request from the host 40. The first server 10 creates the remote copy information T20 related to the remote copy target file 34 stored in the logical volume 33, and stores the information in the shared memory 14.

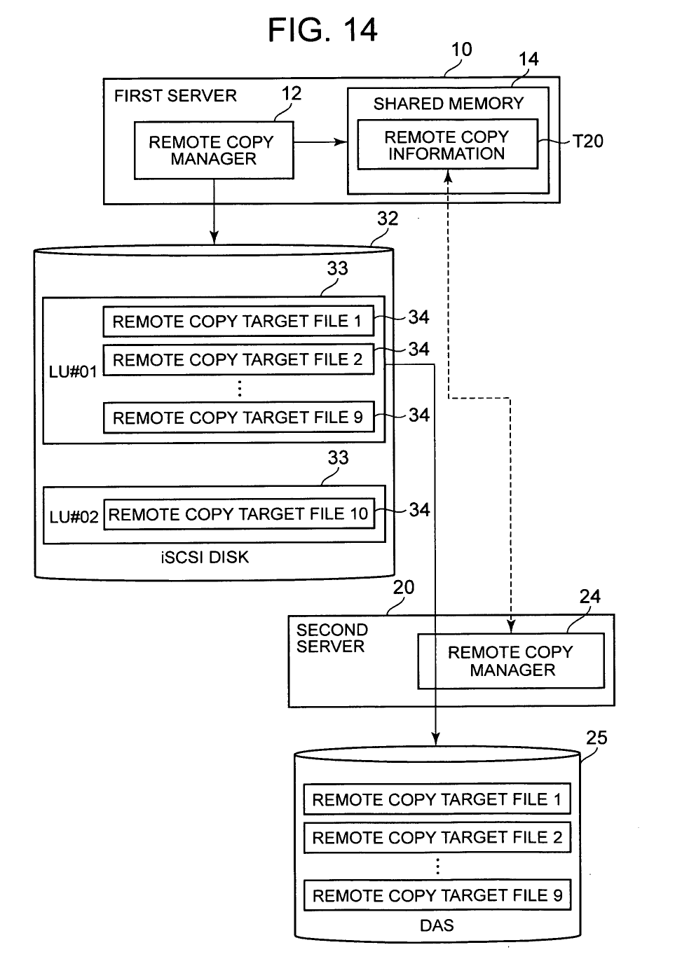

FIG. 14 is a schematic diagram showing how the second server 20 reads out the remote copy target file 34 from the logical volume 33, and stores the file 34 in the DAS 25.

The second server 20, as described above, accesses the logical volume 33 in accordance with respective commands received from the host 40. In this embodiment, the first server 10 centrally manages permission to use the logical volume 33. Therefore, the second server 20 must obtain the lock for the logical volume 33 that it wants to use from the first server 10.

The remote copy manager 22 of the second server 20 acquires the remote copy information T20 inside the shared memory 14 when the logical volume 33 lock is acquired. The remote copy manager 22 determines, based on the remote copy information T20, whether or not the remote copy target file 34 exists inside the currently mounted logical volume 33.

The remote copy manager 22, upon discovering the remote copy target file 34, reads out the remote copy target file 34 from the logical volume 33, and stores the file in the DAS 25 inside the second server 20.

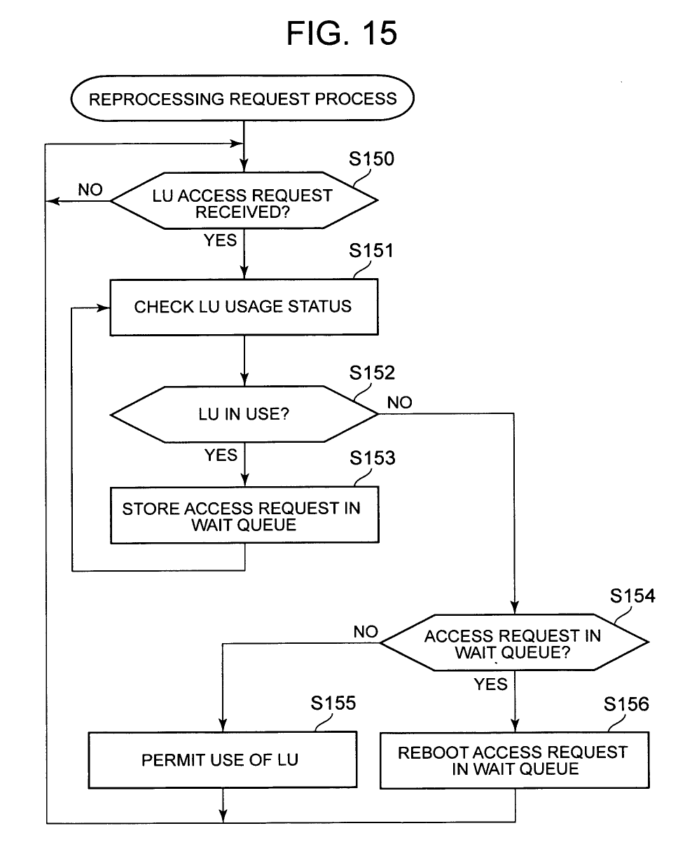

FIG. 15 is a flowchart for executing a reprocessing request. When the access-destination logical volume 33 cannot be mounted, the reprocessing request process is for adding an access request to the wait queue, and processing the access request after it becomes possible to mount the logical volume 33. The reprocessing request process can be executed only by the first server 10, or it can be executed by both the first server 10 and the second server 20. For convenience sake, the first server 10 will be the subject of the explanation provided here.

The first server 10 determines whether or not a request to access the logical volume 33 has been received from the host 40 (S150). An access request, for example, can be a write request, a read request, or a check request.

The first server 10, upon receiving an access request (S150: YES), checks the usage status of the logical volume 33 on the basis of the device usage status management information T12 (S151). The first server 10 determines whether or not the logical volume 33 is in use, that is, whether or not the lock for the logical volume 33 can be acquired (S152).

When the logical volume 33 is used (S152: YES), that is, when it is not possible to acquire the lock for the logical volume 33 (S152: YES), the first server 10 stores the access request received in S150 in the wait queue (S153), and returns to step S151. The first server 10 reports to the host 40 to the effect that processing is not possible regarding the access request added to the wait queue.

The first server 10 regularly or irregularly monitors the usage status of the logical volume 33 (S151). When it becomes possible to use the logical volume 33 (S152: NO), the first server 10 determines whether or not the access request is stored in the wait queue (S154).

When the access request is stored in the wait queue (S154: YES), the first server 10 reboots the access request stored in the wait queue (S156). In other words, the first server 10 reissues the access request from the host 40 (S156). When the access request is not stored in the wait queue (S154: NO), the first server 10 allows use of the logical volume 33 for the access request received in S150 (S155).

Thus, when the access-destination logical volume 33 cannot be mounted, the first server 10 notifies the host 40 to the effect that the access request cannot be processed, and registers the access request in the wait queue. When it becomes possible to mount the logical volume 33, the first server 10 reissues the access request from the host 40.

According to this embodiment, which is configured thusly, since the first server 10 centrally manages permission to use the logical volume 33 inside the iSCSI disk 32, a plurality of servers 10, 20 are able to share a single logical volume 33.

According to this embodiment, when the second server 20 uses the logical volume 33, the remote copy target file 34 stored in the logical volume 33 is copied to the DAS 25 of the second server 20. When the second server 20 mounts the logical volume 33 to process a write command or a read command, the remote copy target file 34, which is unrelated to the write command or the read command, is read out from the logical volume 33. Therefore, when the remote copy target file 34 is copied from the first server 10 to the second server 20 by way of the logical volume 33, it is possible to reduce the number of times that the second server 20 mounts the logical volume 33. Reducing the mounting frequency makes it possible to enhance the response performance of the network storage device 30.

In this embodiment, file data having a large data size is stored in the DAS 15 as cache data, and DB data having a small data size is stored in the memory 14 as cache data. Therefore, it is possible to hold down on cases in which the memory 14 becomes filled up with large-size file data.

In this embodiment, when the access-destination logical volume 33 cannot be used, the access request is registered in the wait queue, and the processing is ended for a time. Thereafter, when it becomes possible to use the logical volume 33, the access request registered in the wait queue is reissued from the host 40. Therefore, the host 40 does not have to continue to wait until the access-destination logical volume 33 becomes usable, and can carry out other processing until the logical volume 33 is capable of being used.

Furthermore, the process for writing the remote copy target file from the first server 10 to the logical volume 33 can also be called remote copy pre-processing, and the process in which the second server 20 reads out the remote copy target file from the logical volume 33 can also be called remote copy post-processing. In this embodiment, when these processes are referred to like this, remote copy pre-processing and the remote copy post-processing are carried out asynchronously, and remote copy post-processing is started when the second server 20 accesses the logical volume 33.

### Second Embodiment

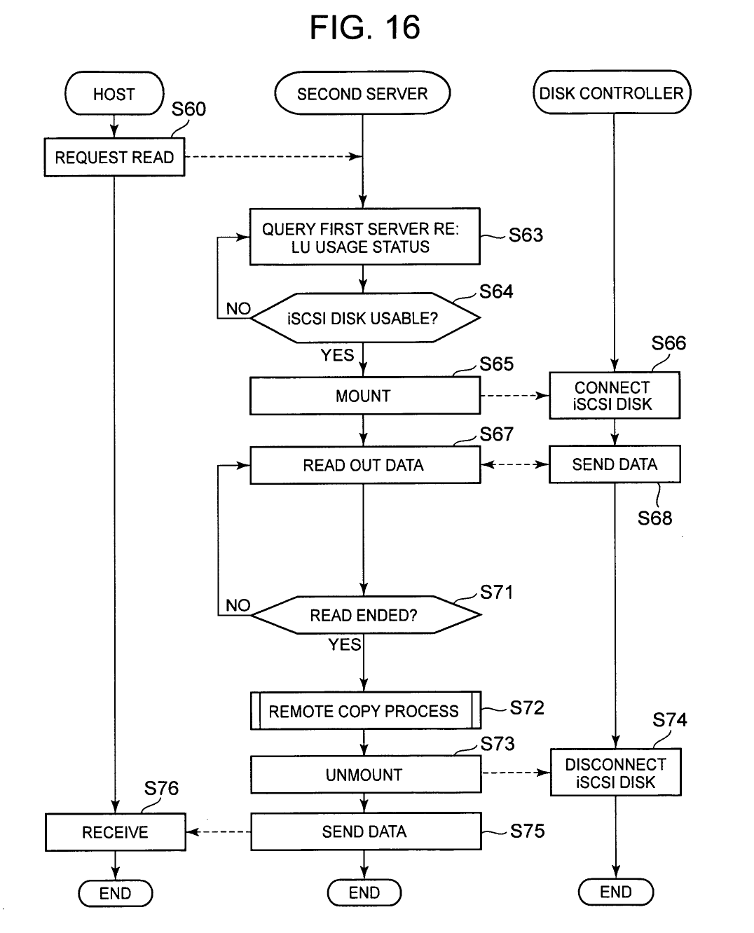

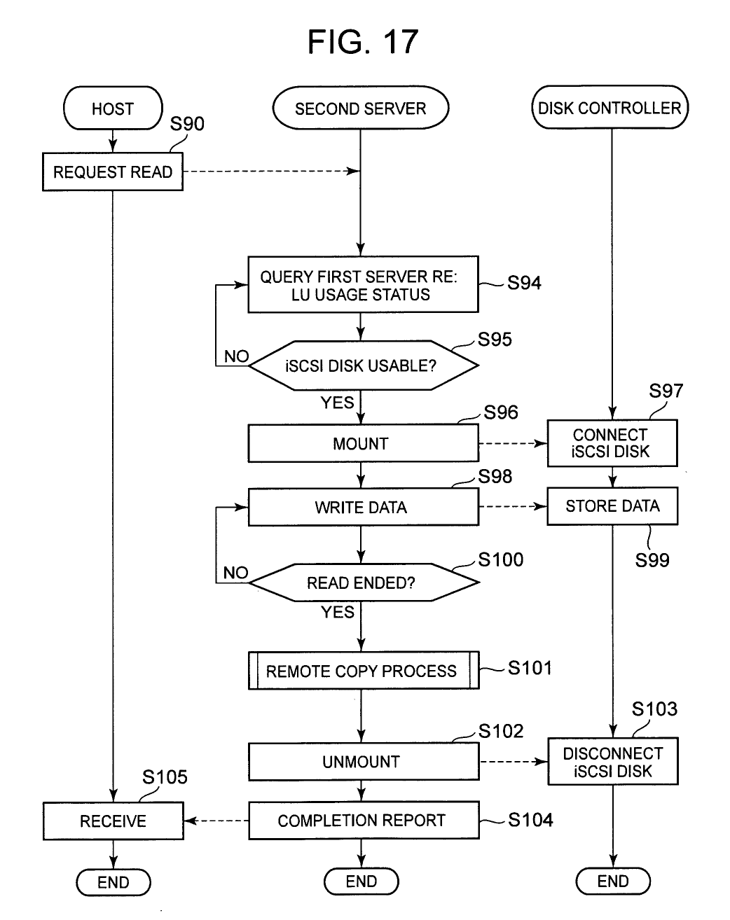

A second embodiment will be explained on the basis of FIGS. 16 and 17. The embodiments that follow, to include this embodiment, correspond to variations of the first embodiment. Therefore, explanations that duplicate those given for the first embodiment will be omitted, and the explanation will focus on the characteristic features of this embodiment. In this embodiment, as will be described hereinbelow, cache data management is excluded.

FIG. 16 is a flowchart of a read process executed by the second server 20. The process comprises all the steps of the respective steps of S60 through S76 shown in FIG. 8, with the exception of steps S61, S62, S69 and S70 related to the management of cache data.

FIG. 17 is a flowchart of a write process executed by the second server 20. The process comprises all of the respective steps from S90 through S105 shown in FIG. 10, with the exception of steps S91 through S93 related to the management of cache data.

Thus, the second server 20 of this embodiment does not carry out cache data management. This embodiment, which is configured thusly, also exhibits the same effects as the first embodiment.

### Third Embodiment

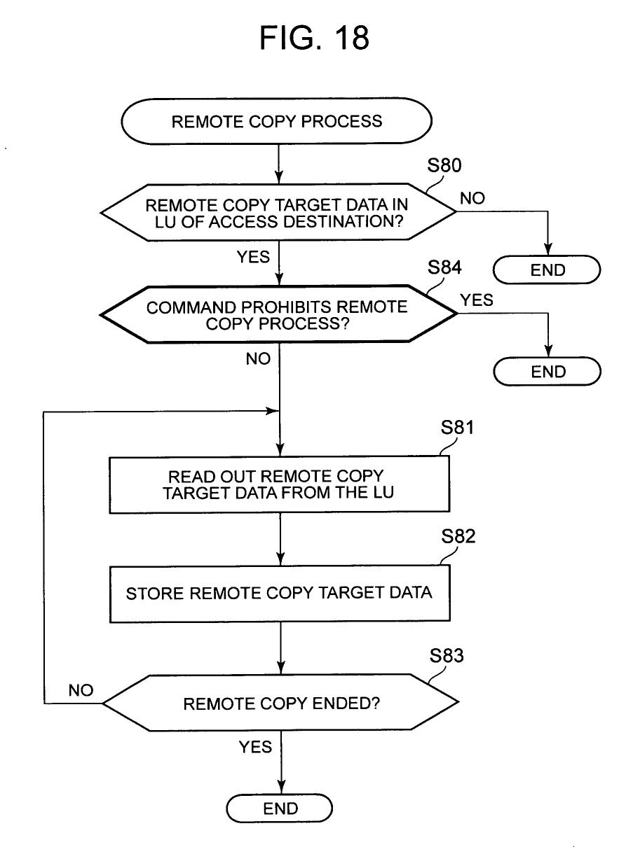

A third embodiment will be explained on the basis of FIG. 18. This embodiment shows a variation of the processing of FIG. 9. FIG. 18 is a flowchart of a remote copy process in accordance with this embodiment. The process comprises all of the respective steps from S80 through S83 shown in FIG. 8. In addition, the process adds a new step S84 between steps S80 and S81.

In the new step S84, it is determined whether or not the command received from the host 40 prohibits the implementation of the remote copy process (S84). When the command prohibits the remote copy process (S84: YES), the second server 20 ends the processing. The second server 20 does not read out the remote copy target file even when the remote copy target file 34 exists inside the mounted logical volume 33.

By contrast, when the command received from the host 40 does not prohibit a remote copy process (S84: NO), the second server 20 reads out the remote copy target file 34 from the logical volume 33 (S81), and stores the file 34 in the DAS 25 (S82, S83) the same as described in FIG. 9.

The execution of the remote copy process can be prohibited, for example, by configuring a prescribed parameter prepared beforehand in the various commands (the various access requests), such as the write command, read command, and check command. For example, when a prescribed parameter is configured inside a read command that the host 40 issues to the second server 20, the second server 20 does not read out the remote copy target file even though the logical volume 33 corresponding to the read command has been mounted.

This embodiment, which is configured thusly, exhibits the same effects as the first embodiment. Furthermore, in this embodiment, upon receiving a command that prohibits the execution of the remote copy process, the second server 20 executes only the processing related to the command, and does not read out the remote copy target file 34 from the logical volume 33. Therefore, it is possible to rapidly report to the host 40 the result of processing the command received from the host 40.

Furthermore, even in the first embodiment, the configuration can be such that the result of a read process or the result of a write process is reported to the host 40 prior to commencing the remote copy process (S72, S101), and the remote copy process is carried out subsequent to the end of the report. In this case, the result of the command process requested by the host 40 can be notified to the host 40 quickly, and the remote copy process can be carried out thereafter.

### Fourth Embodiment

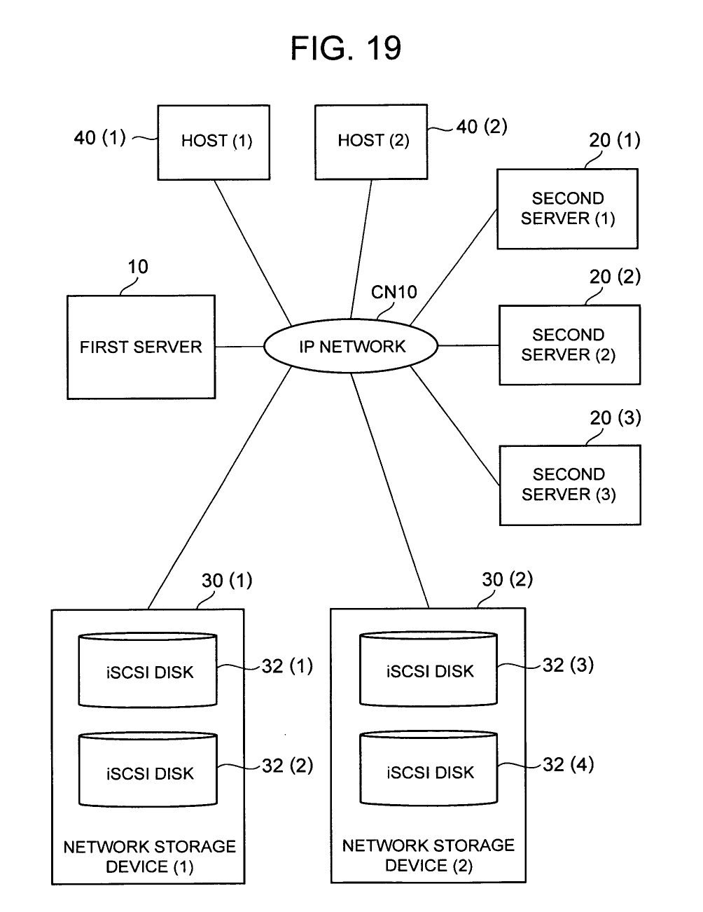

FIG. 19 is a block diagram of the entire computer system related to a fourth embodiment. In the first embodiment, one each of a first server 10, a second server 20, a network storage device 30 and a host 40 were shown.

Instead of this, it is possible to configure the computer system from a first server 10, a plurality of second servers 20(1) through 20(3), a plurality of network storage devices 30(1) and 30(2), and a plurality of hosts 40(1) and 40(2). The respective network storage devices 30(1), 30(2) can each comprise a plurality of iSCSI disks. In the example shown in the figure, the one network storage device 30(1) comprises iSCSI disks 32(1) and 32(2), and the other network storage device 30(2) comprises iSCSI disks 32(3) and 32(4).

The first server 10 centrally manages permission to use the respective iSCSI disks 32 inside the respective network storage devices 30. The respective second servers 20 acquire the lock for the desired logical volume from the first server 10, and mount the desired logical volume.

This embodiment, which is configured thusly, also exhibits the same effects as the first embodiment. Furthermore, in this embodiment, a larger number of servers can make shared use of a logical volume inside a network storage device 30.

### Fifth Embodiment

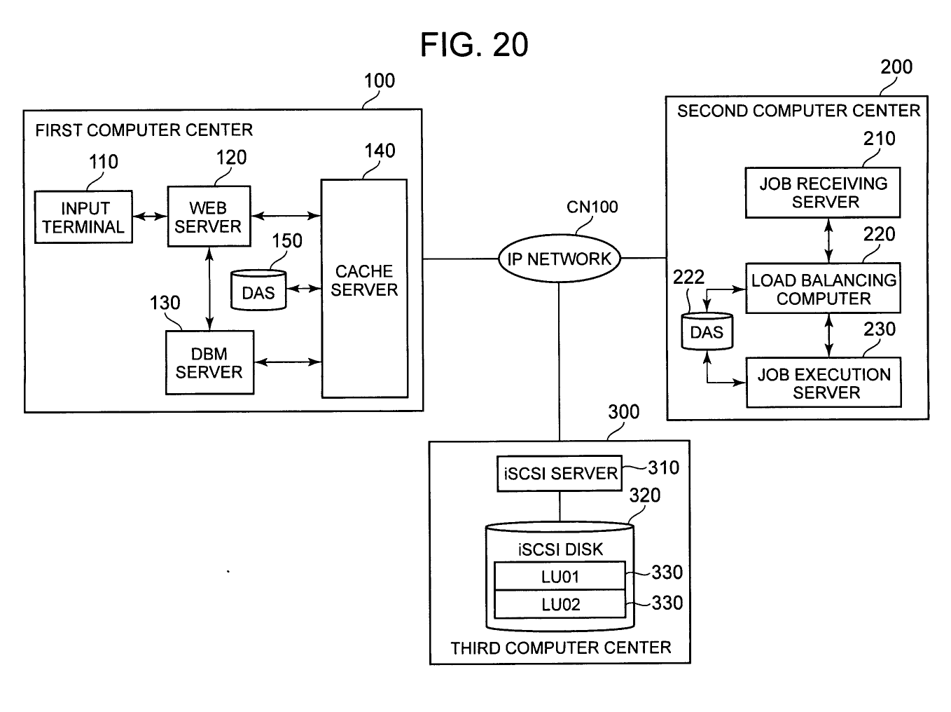

A fifth embodiment will be explained on the basis of FIGS. 20 through 28. In this embodiment, the issuing of commands, managing of permission to use the iSCSI disk 320, and managing of cache data are carried out inside a first computer center 100. A second computer center 200 uses the iSCSI disk 320 in accordance with a command issued from the first computer center 100.

The corresponding relationship with the first embodiment will be explained. The first computer center 100 corresponds to the “first computer”. The first computer center 100 corresponds to a first server 10 and a host 40. The second computer center 200 corresponds to the “second computer”. The second computer 200 corresponds to a second server 20. A third computer center 300 corresponds to a “shared storage device”. The third computer center 300 corresponds to the network storage device 30.

The first computer center 100, second computer center 200 and third computer center 300 are respectively connected to a communication network CN100, such as an IP network.

The first computer center 100, for example, comprises an input terminal 110; web server 120; DBM server 130; cache server 140; and DAS 150. The web server 120, DBM server 130, and cache server 140 can be disposed inside the same computer, or can also be configured as separate computers.

The second computer center 200, for example, comprises a job receiving server 210; load balancing computer 220; job execution server 230; and DAS 222. The respective devices 210 through 230 can be disposed inside the same computer, or can be configured as separate computers.

The third computer center 300, for example, comprises an iSCSI server 310; and iSCSI disk 320. A logical volume 330 is provided in the iSCSI disk 320.

FIG. 20 is a schematic diagram showing the configuration of the first computer center 100. The input terminal 110 is communicably connected to the web server 120. The cache server 140 is communicably connected to the web server 120 and the DBM server 130.

The input terminal 110, for example, comprises a client program 111, such as a web browser. The client program 111 is a program for using an application program 121 inside the web server 120.

The web server 120, for example, comprises an application program 121; I/O command 122; and cache server communication unit 123. The application program 121, for example, can be configured as a program from carrying out circuit design.

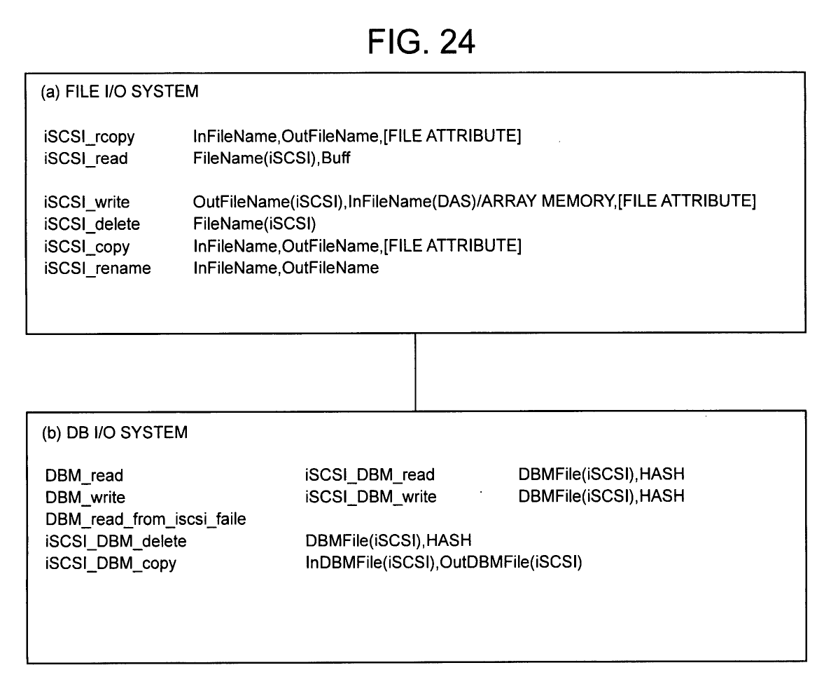

The I/O command 122 is for inputting/outputting data to/from the iSCSI disk 320. The I/O command 122 selects an appropriate command from among a group of pre-configured commands in accordance with an indication from the application program 121, and issues the selected command. An example of the I/O command will be explained hereinbelow using FIG. 24. The cache server communication unit 123 is for carrying out communications with the cache server 140.

The cache server 140, for example, comprises a server controller 141; and iSCSI initiator 142. The server controller 141 is for controlling the operation of the cache server 140. The server controller 141 comprises a shared memory cache unit 143; and I/O client unit 144.

The shared memory cache unit 143 can be accessed by the load balancing computer 220 and the job execution computer 230. The shared memory cache unit 143, for example, stores DB cache data CD2 and remote copy information T20. Furthermore, in the following explanation, the shared memory cache unit may be called a shared memory or a shared memory cache.

The I/O client unit 144 is for mounting or unmounting the iSCSI initiator 142 in accordance with a command issued by I/O command 122. The iSCSI initiator 142 is for carrying out communications with the ISCSI server 310, which constitutes the iSCSI target.

The DBM server 130 comprises a DBM server program 131. DBM is the abbreviation for database management. Cache data used by the DBM server program 131 is stored in the shared memory cache unit 143 as DB cache data.

The DAS 150, for example, stores file cache data CD1 used by the application program 121, and management information T10.

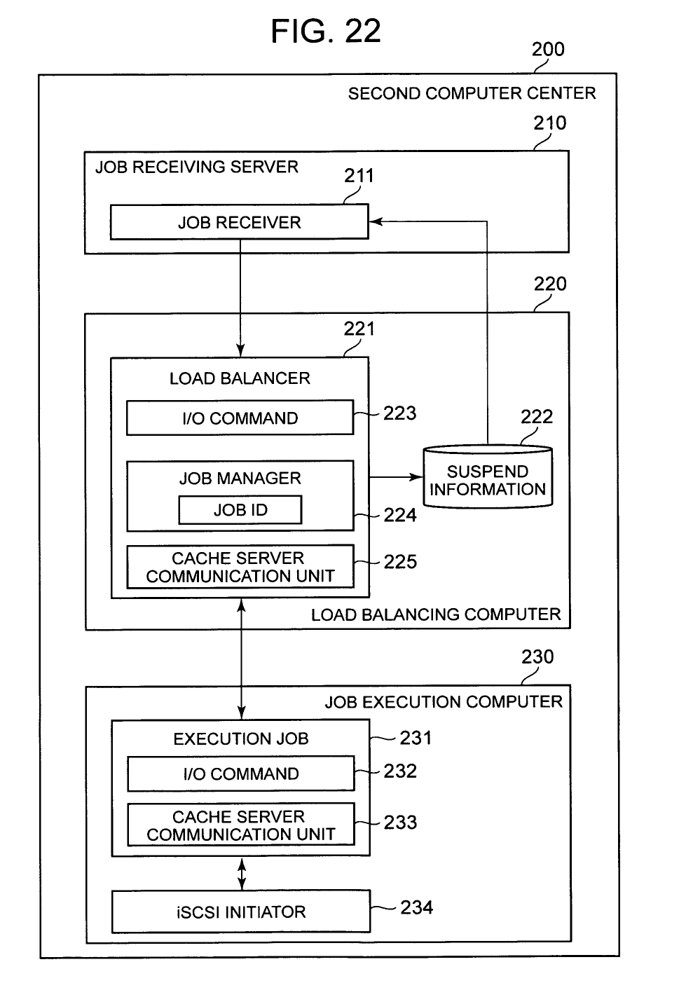

FIG. 22 is a schematic showing an example of the configuration of the second computer center 200. The job receiving server 210 and load balancing computer 220 are communicably connected. The load balancing computer 220 and the job execution computer 230 are communicably connected.

The job receiving server 210 is a server for receiving a job issued by the web server 120, and comprises a job receiver 211. For example, as in the embodiments to be explained hereinbelow, the job receiving server 210 receives from the web server 120 a circuit design program simulation or the like. The job receiver 211 requests the load balancing computer 220 to execute the received job.

The load balancing computer 220 manages which computer (CPU) will be allocated the job requested by the job receiving server 210. The load balancing computer 220, for example, comprises a load balancer 221; and DAS 222. The DAS 222 can store a remote copy target file and suspend information.

The load balancer 221, for example, comprises an I/O command 223; job manager 224; and cache server communication unit 225. The I/O command 223 issues a command for inputting/outputting data to/from the iSCSI disk 320.

The job manager 224 allocates and manages a job ID for a job requested by the job receiving server 210. The job manager 224 queries the cache server 140 for permission to use the logical volume 330 of the iSCSI disk 320. When the logical volume 330 is able to be used, the job manager 224 determines the computer 230 that will execute the job, and requests the processing of the job. When the logical volume 330 cannot be used, the job manager 224 creates suspend information and stores the information in the DAS 222. In other words, the job manager 224 adds the job to the wait queue.

The cache server communication unit 225 is for communicating with the cache server 140 regarding permission to use the logical volume and the presence or absence of remote copy information T20.

The job execution computer 230, for example, comprises an execution job 231; and iSCSI initiator 234. The execution job 231 comprises an I/O command 232; and cache server communication unit 233.

The execution job 231 is created for each job requested by the load balancing computer 220. The I/O command 232 is a command for processing the job. The cache server communication unit 233 is for communicating with the cache server 140.

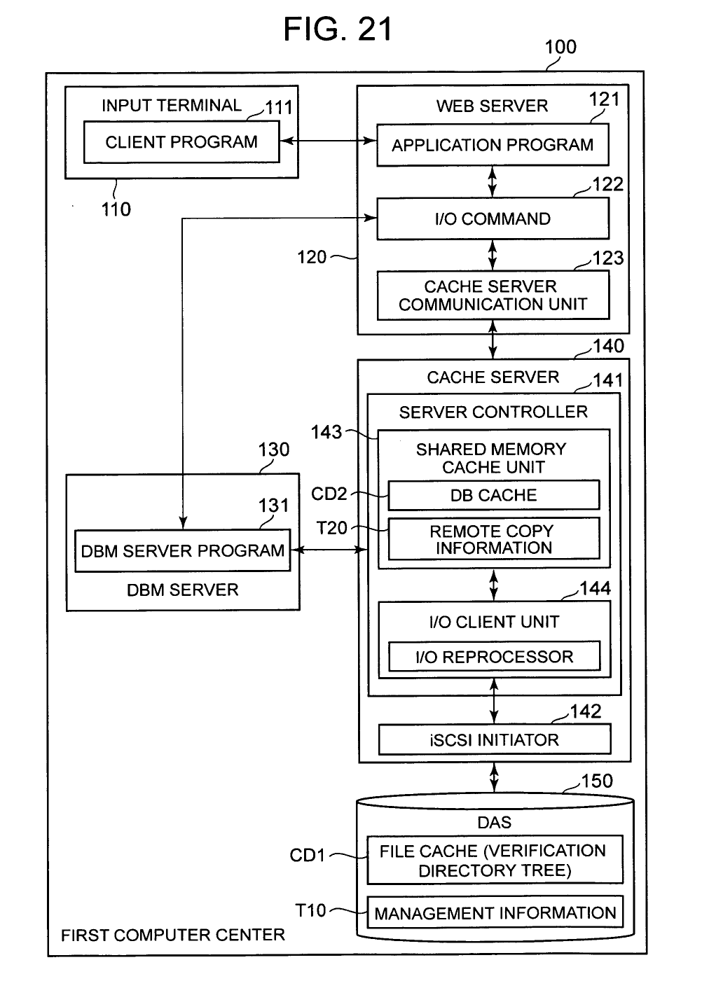

At least one portion of the configuration shown in FIGS. 21 and 22 is configured as a program. For example, at least one of the web server 120, cache server 140, DBM server 130, job receiving server 210, load balancing computer 220 and job execution computer 230 is a program.

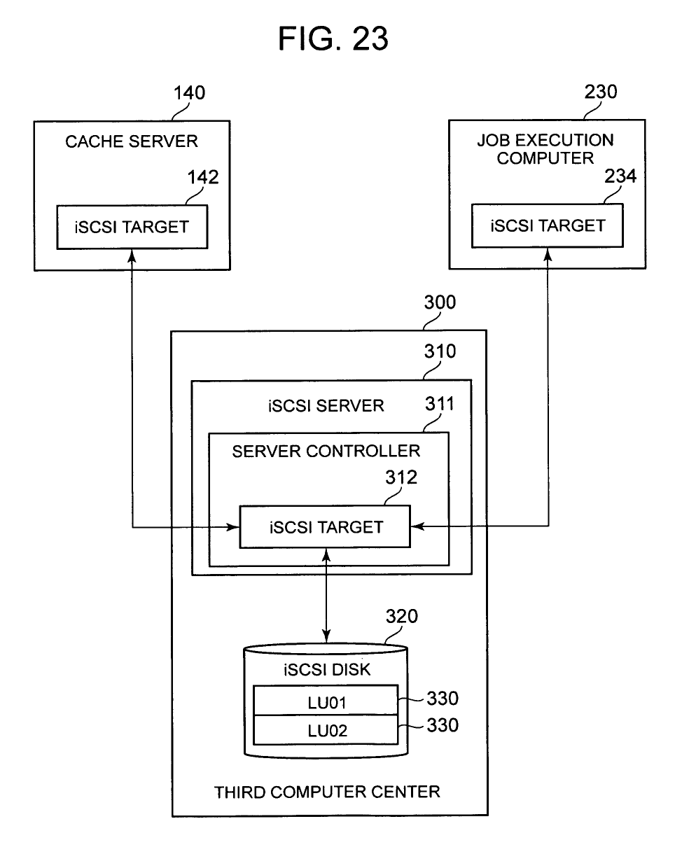

FIG. 23 shows how the cache server 140 and job execution computer 230 share the logical volume 330 of the iSCSI disk 320. Either the cache server 140 or the job execution computer 230 can make exclusive use of the logical volume 330 inside the iSCSI disk 320.

The cache server 140 centrally manages the logical volume 330 lock. Therefore, the load balancing computer 220 and the job execution computer 230 acquire the logical volume 330 lock by communicating with the cache server 140.

FIG. 24 is a schematic diagram showing an example of a command group. The I/O commands 122, 223, 232 issue the commands shown in FIG. 24. FIG. 24(a) shows file I/O commands. A file I/O command, for example, is used relative to the application program 121.

In this embodiment, as file I/O commands, for example, there are provided iSCSI_rcopy (InFileName,OutFileName [file attribute]); iSCSI_read (FileName(iSCSI),Buff), iSCSI_write (OutFileName(iSCSI), InFileName(DAS)/arrayed memory, [File attributes]), iSCSI_delete (FileName(iSCSI)), iSCSI_copy (InFileName, OutFileName,[file attribute]), and iSCSI_rename (InFileName,OutFileName). Examples of parameters are included inside parentheses.

iSCSI_rcopy is a command for carrying out a remote copy using the logical volume 330 of the iSCSI disk 320. iSCSI_read is a command for reading out file data from the logical volume 330. iSCSI_write is a command for writing file data to the logical volume 330. iSCSI_delete is a command for deleting a file from inside the logical volume 330. iSCSI_copy is a command for copying a file that is inside the logical volume 330. iSCSI_rename is a command for changing a filename that is inside the logical volume 330. Furthermore, iSCSI_rename can also carry out file migration.

FIG. 24(b) shows a DB-I/O command. A DB-I/O command is used in relation to DBM server program 131.

In this embodiment, as DB-I/O commands, for example, there are prepared a DBM_read (iSCSI_DBM_read DBMFile(iSCSI), HASH); DBM_write (iSCSI_DBM_write DBMFile(iSCSI), HASH); DBM_read_from_iscsi_file; and iSCSI_DBM_delete (DBMFile(iSCSI), HASH); and iSCSI_DBM_copy (InDBMFile(iSCSI), OutDBMFile(iSCSI)).

DBM_read is a command for writing DB data to the logical volume 330 of the iSCSI disk 320. DBM_write is a command for reading DB data from the logical volume 330. DBM_read_from_iscsi_file is a command for reading out DB data from the logical volume 330 and creating cache data. iSCSI_DBM_delete is a command for deleting the DB data that is inside the logical volume 330. iSCSI_DBM_copy is a command for copying the DB data that is inside the logical volume 330.

Furthermore, the above-mentioned commands are examples, and the scope of the present invention is not limited to the group of commands shown in FIG. 24.

FIG. 25 is a schematic diagram illustrating the management of cache data. FIG. 25(a) shows the directory structure when the logical volume 330 is mounted to “/iSCSI1” as an iSCSI device. File A is stored inside directory B under directory A. File A comprises data 1 and data 2.

FIG. 25(b) shows the directory structure when file A data is cached as cache data CD1. File A is stored inside directory B in the DAS 150 by way of a hidden directory “.CACHE (Dir)”. The hidden directory shows that the storage area is a cache area.

FIG. 25(c) shows an example of the verification directory structure, which is used for a test command. Mount verification information is stored inside file A. Mount verification information, for example, can include information, which specifies the logical volume 330 inside the iSCSI disk 320, such as “iSCSI LU=/dev/sda2 mount_dir=/ISCSI2”, and information, which shows the mount destination when the logical volume 330 is mounted. In this embodiment, a system failure is prevented by determining whether or not a determined mount pointer coincides with the mount verification information. Furthermore, for example, preparing the test command directory tree shown in FIG. 25 (c) makes it possible to use a conventional test command as-is when the application program 121 checks for the existence of a file.

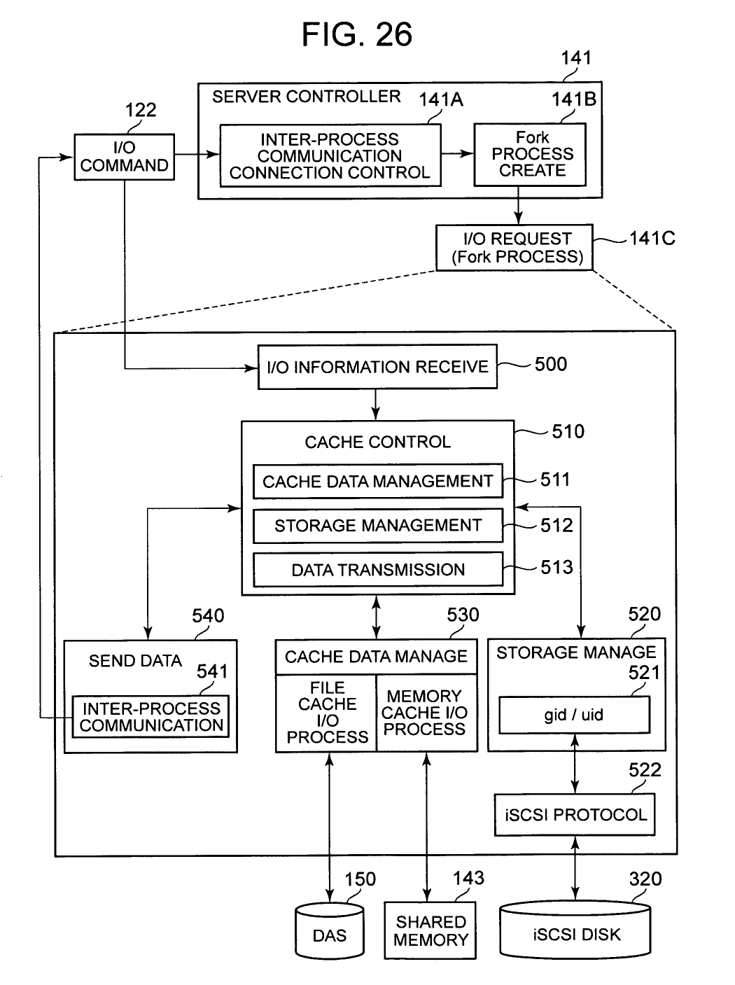

FIG. 26 shows the configuration of the server controller 141 of the cache server 140. The server controller 141, for example, comprises inter-process communication connection control 141A; and Fork process create 141B.

Inter-process communication connection control 141A receives an I/O command 122 like that shown in FIG. 24 from the web server 120. Fork process create 141B creates an I/O request 141C corresponding to the received I/O command.

The I/O request 141C, for example, comprises I/O information receive 500; cache control 510; storage manage 520; cache data manage 530; data send 540.

I/O information receive 500 is for acquiring from the I/O command 122 information related to the I/O command. For example, in the case of a write command, I/O information receive 500 acquires from the I/O command 122 information as to what is to be written where in which logical volume 330. In the case of a read command, the I/O information receive 500 acquires from the I/O command 122 information as to what data is to be read out from where in which logical volume 330.

Cache control 510, for example, comprises a cache data management function 511; storage management function 512; and data transmission function 513.

The cache data management function 511 uses cache data manage 530 to manage the cache data. Cache data manage 530 comprises a file cache I/O process, and a memory cache I/O process. File data CD1 is stored in the DAS 150 by the file cache I/O process. DB data CD2 is stored in the shared memory 143 by the memory cache I/O process.

The storage management function 512 uses storage manage 520 to access the logical volume 330 inside the iSCSI disk 320. Storage manage 520 executes exclusive control for sharing the iSCSI disk 320. Storage manage 520 switches process execution authority to the user (uid), and uses the iSCSI protocol 522 to mount or unmount the logical volume 330 of the iSCSI disk 320.

The data transmission function 513 uses data send 540 to send data to the web server 120. Data send 540 returns data read out from the logical volume 330 to the I/O command 122 via an inter-process communication 541. The I/O command 122 delivers the received data to the application program 121.

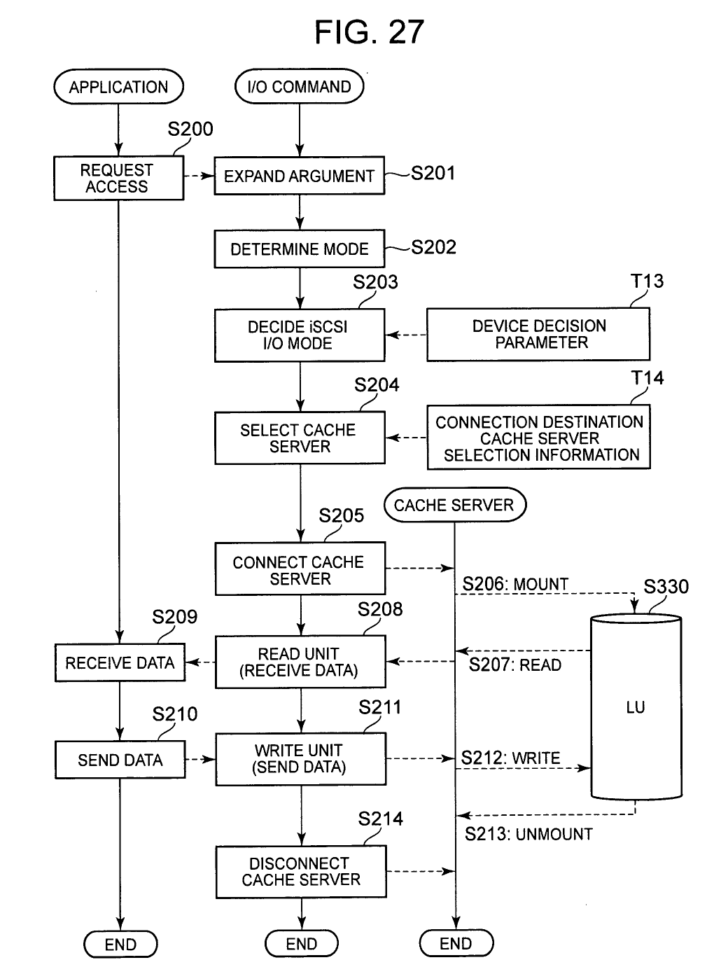

FIG. 27 is a flowchart showing a read command process and a write command process. The web server 120 application program 121 issues an access request to the I/O command 122 in accordance with an operation from the input terminal 110 (S200).

The I/O command 122 expands an argument, and, for example, determines a filename specified by the absolute path (S221). Consequently, the I/O command 122 can learn if the process-targeted file is in the DAS 150, or in the logical volume 330 of the iSCSI 320.

The I/O command 122 decides the iSCSI-I/O mode based on the name of the web server 120 on which the application program 121 is running, and a device decision parameter T13 (S202, S203). The iSCSI-I/O mode shows whether or not the I/O mode of the iSCSI disk 320 is the mode for mounting the logical volume 330 by way of the cache server 140. The device decision parameter T13, for example, stipulates in advance the logical device (logical volume 330 and the like) that the host (here, the web server 120) can use.

The I/O command 122 uses connection-destination cache server selection information T14 to select the connection-destination cache server 140 (S204). The connection-destination cache server selection information T14 comprises information for specifying the cache server 140 to be used; and information related to the mount point.

The I/O command 122 connects to the cache server 140, and notifies the cache server 140 of the filename (S205).

The cache server 140 determines whether or not the logical volume 330 storing the specified file is mountable, and if it is determined that the logical volume 330 is mountable, mounts the logical volume 330 (S206).

When the I/O command 122 is a read command, the cache server 140 reads out the data from the logical volume 330 (S207), and sends the data to the I/O command 122. The I/O command 122 delivers the data received from the cache server 140 to the application program 121 (S208, S209).

When the I/O command 122 is a write command, the I/O command 122 sends the data received from the application program 121 to the cache server 140 (S210). The cache server 140 writes the data received from the I/O command 122 to a specified location inside the logical volume 330 (S212).

The cache server 140 unmounts the logical volume 330 when the processing requested by the I/O command 122 is complete (S213). The I/O command 122 deletes the connection to the cache server 140, and releases the communication connection (S214).

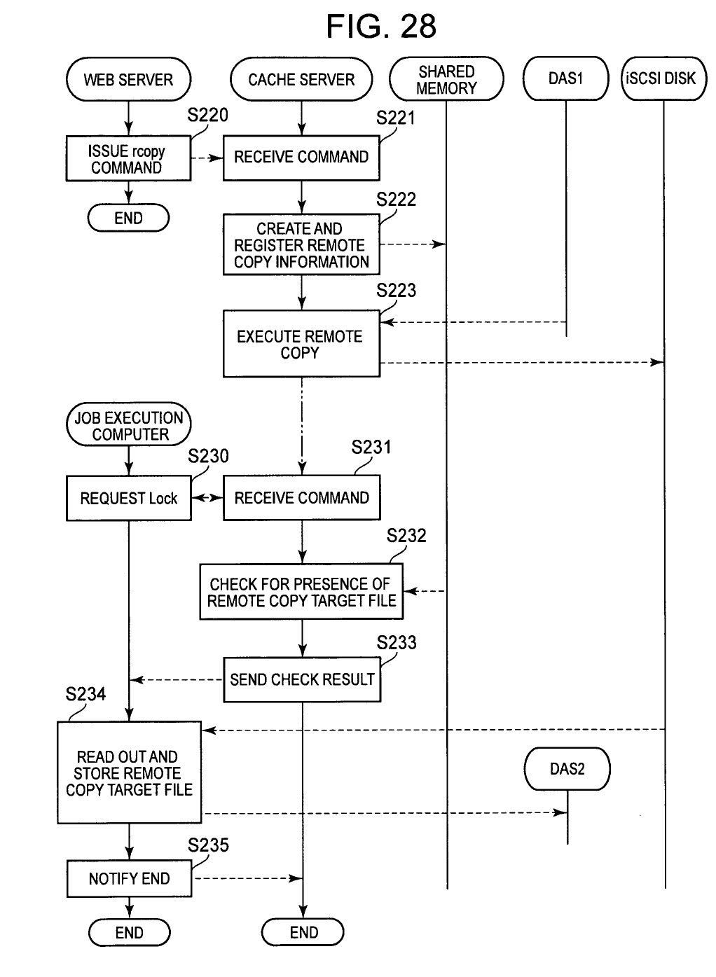

FIG. 28 is a flowchart showing a remote copy process. The situation described here assumes that the cache server 140 has already mounted the logical volume 330.

The web server 120 issues a remote copy command (rcopy command in the figure) to the cache server 140 (S220). The cache server 140, upon receiving the remote copy command (S221), creates remote copy information T10, and registers the remote copy information T10 in the shared memory 143 (S222).

The cache server 140 reads out the remote copy target file from the DAS 150 (displayed as DAS 1 in the figure), transfers the read-out remote copy target file to the logical volume 330, and stores the file in the logical volume 330 (S223). For convenience sake, a file data remote copy will be described, but a remote copy can also be carried out for DB data.

The job execution computer 230, based on an indication from the web server 120, uses the logical volume 330 in which the remote copy target file has been stored. The job execution computer 230 requests the cache server 140 for lock acquisition (S230).

The cache server 140, upon receiving the command (Lock request) from the job execution computer 230, determines if the job execution computer 230 is able to use the logical volume 330.

When it is determined that the job execution computer 230 is able to use the logical volume 330, the cache server 140 provides the lock related to the logical volume 330 to the job execution computer 230 (S231). The job execution computer 230 mounts the logical volume 330, and executes the processing indicated from the web server 120.

The cache server 140 references the remote copy information T10 inside the shared memory 143, and determines whether or not the remote copy target file is comprised inside the logical volume 330 to be used by the job execution computer 230 (S232).

When the logical volume 330 comprises the remote copy target file, the cache server 140 notifies the job execution computer 230 of the filename of the remote copy target file (S233).

On the basis of the notification received from the cache server 140, the job execution computer 230 reads out the remote copy target file from the logical volume 330, and stores the read-out remote copy target file in a prescribed location of the DAS 222 (displayed as DAS 2 in the figure) (S234).

The job execution computer 230, upon completing the data copy from the logical volume 330 to the DAS 222, notifies the cache server 140 that processing has ended (S235). This embodiment, which is configured thusly, also exhibits the same effects as the first embodiment.

### Sixth Embodiment

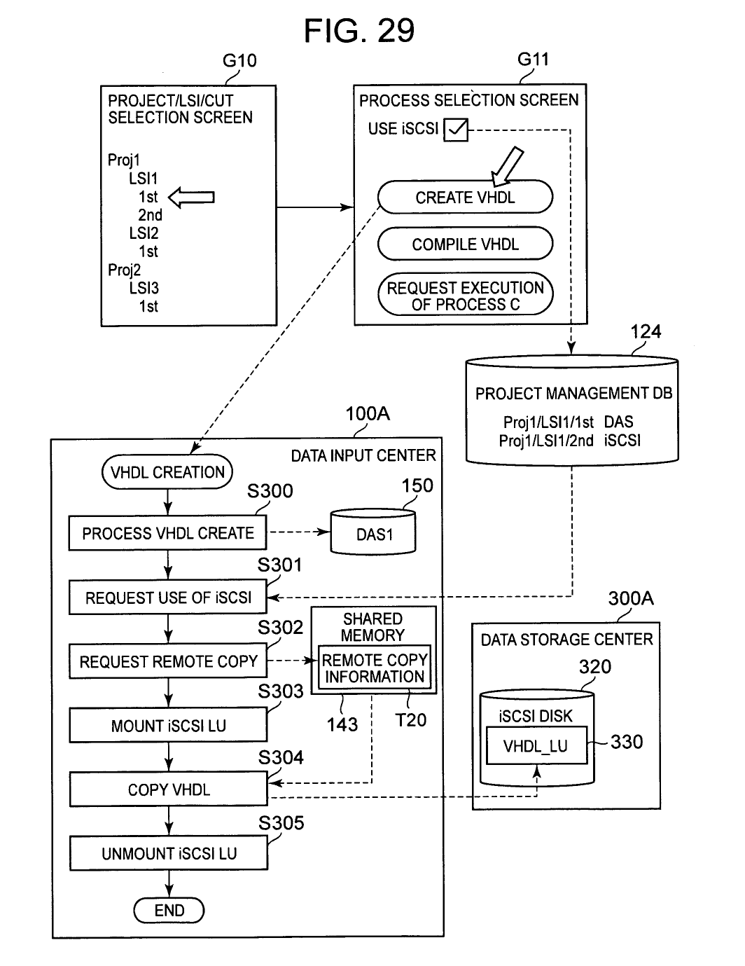

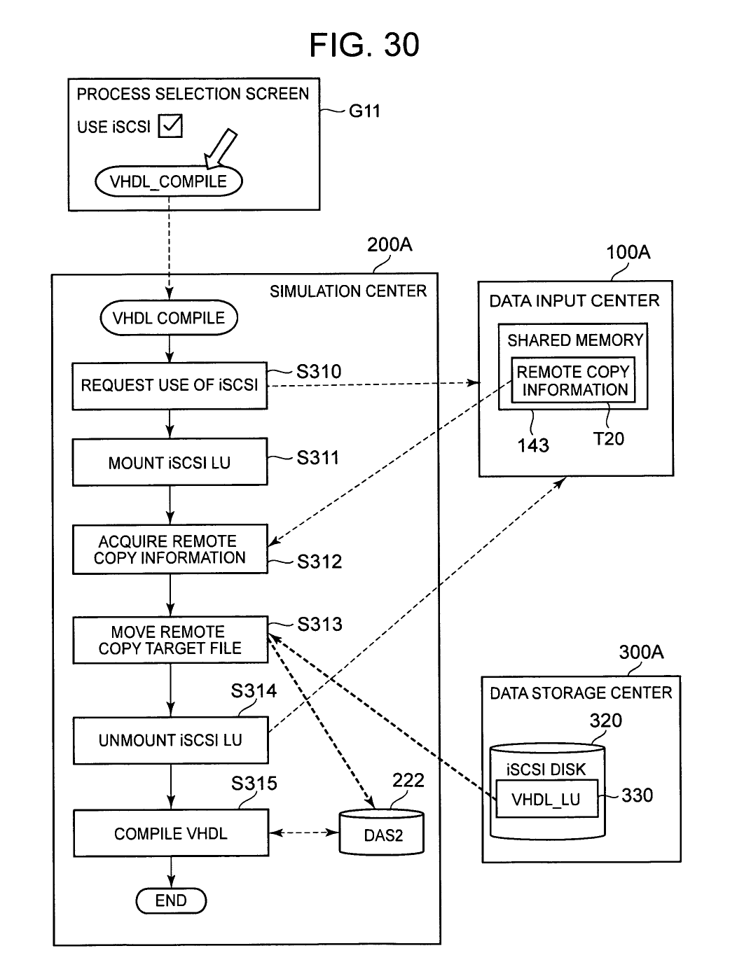

A sixth embodiment will be explained on the basis of FIGS. 29 and 30. This embodiment corresponds to a specific example of the fifth embodiment. FIG. 29 shows the configuration of a data input center 100A side, and FIG. 30 shows the configuration of a simulation center 200A side.

The data input center 100A corresponds to the first computer center 100, the simulation center 200A corresponds to the second computer center 200, and a data storage center 300A corresponds to the third computer center 300.

In the computer system according to this embodiment, the data input center 100A, simulation center 200A and data storage center 300A are respectively connected to an IP network.

The data input center 100A creates VHDL (Very high-speed integrated circuit Hardware Description Language) data. The data storage center 300A stores the VHDL data inside the logical volume 330. The simulation center 200A reads out the VHDL data from the logical volume 330, stores the VHDL data in the DAS 222, and compiles the VHDL data.

The user uses the input terminal 110 to access the web server 120. As shown at the top of FIG. 29, the input terminal 110 display device displays a screen G10 for specifying a project, LSI, and so forth. The user specifies a desired LSI and desired cut of a desired project.

A process selection screen G11 is displayed on the display device of the input terminal 110. For example, a type of application program 121, such as VHDL create or VHDL compile, can be specified in the process selection screen G11. Further, the user can specify whether or not to use the iSCSI disk 320 on the process selection screen G11.

When the user selects VHDL create, the result of the selection is registered in a database 124 for managing the project.

The web server 120 inside the data input center 100A (more accurately, the application program 121 for creating the VHDL) creates the VHDL data (S300). The created VHDL data is stored in the DAS 150.

The web server 120 requests the cache server 140 to use the iSCSI disk by referencing the project management database 124 (S301). The web server 120 requests the cache server 140 inside the data input center 100A to carry out a remote copy (S302). Consequently, remote copy information T20 is registered in the shared memory 143.

When the mode is for using the logical volume 330 via the cache server 140, the cache server 140 mounts the logical volume 330 specified by the application program 121 (S303).

The cache server 140 references the remote copy information T20, and copies the VHDL data created in S300 to the logical volume 330 (S304). Subsequent to copying the VHDL data to the logical volume 330, the cache server 140 unmounts the logical volume 330 (S305).

Refer to FIG. 30. The user uses the input terminal 110 to select the VHDL data compile process from the process selection screen G11. In FIG. 30, the process selection screen G11 is shown in simplified form.

The simulation center 200A requests the data input center 100A for permission to use the logical volume 330 (S310). The simulation center 200A, upon obtaining permission to use the logical volume 330 from the data input center 100A, mounts the logical volume 330 (S311).

The data input center 100A determines whether or not the remote copy target file resides inside the logical volume 330 mounted to the simulation center 200A by referencing the remote copy information T20. When the logical volume 330 comprises the remote copy target file (here, the VHDL data written in S304), the data input center 100A sends the remote copy information related to the remote copy target file to the simulation center 200A (S312).

The simulation center 200A reads out the VHDL data, which is the remote copy target file, from the logical volume 330, and writes the read-out VHDL data to the DAS 222 (S313). The simulation center 200A unmounts the logical volume 330 subsequent to completing the remote copy process (S314). The fact that the simulation center 200A has unmounted the logical volume 330 is notified to the cache server 140 of the data input center 100A (S314).

Then, the simulation center 200A compiles the VHDL data, which was written to the DAS 222 (S315). This embodiment, which is configured thusly, also exhibits the same effects as the fifth embodiment.

### Seventh Embodiment

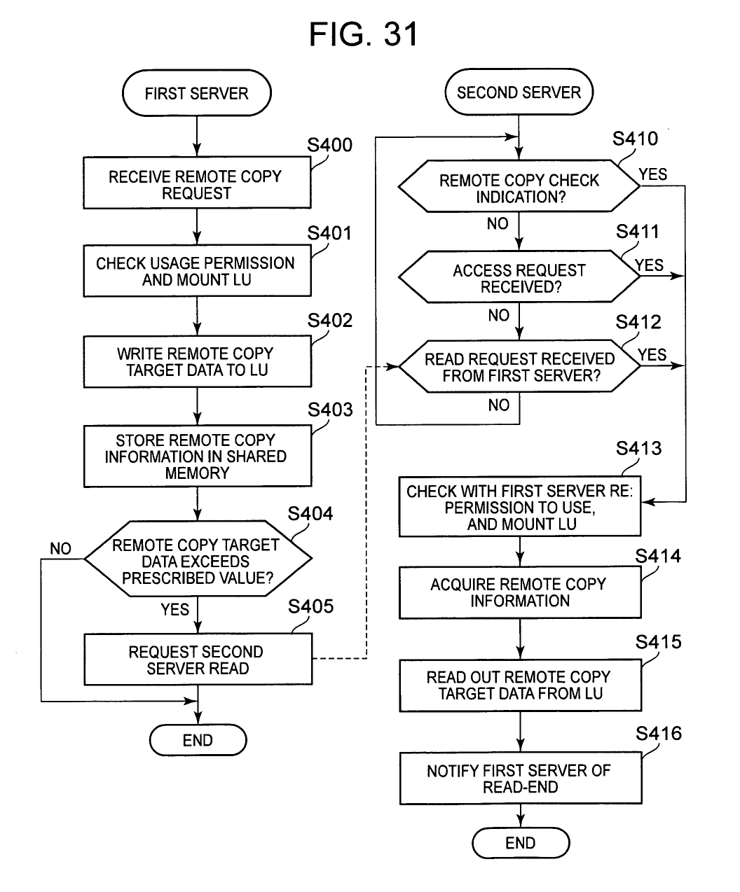

FIG. 31 is a flowchart showing a remote copy process in accordance with a seventh embodiment. In the first embodiment, the opportunity for the second server 20 to read out the remote copy target file from the logical volume 33 was cited as being the timing at which the second server 20 accessed the logical volume 33. That is, in the first embodiment, when the second server 20 uses the logical volume 33, a remote copy target file stored in the logical volume 33 is transferred to the second server 20. By contrast, a different opportunity is proposed in this embodiment.

Upon receiving a remote copy request (S400), the first server 10 determines whether or not it is possible to use the logical volume 33, and when it is possible to use the logical volume 33, the first server 10 mounts the logical volume 33 (S401).

The first server 10 writes the remote copy target file to the logical volume 33 (S402), and unmounts the logical volume 33 after the write has ended. The first server 10 creates remote copy information T20, and registers the created remote copy information T20 in the shared memory 14 (S403).

Next, the first server 10 determines whether or not the remote copy target files accumulated in the logical volume 33 are greater than a prescribed value based on the remote copy information T20 (S404). For example, the first server 10 configures beforehand an upper limit value for the number of remote copy target files to be accumulated in the logical volume 33, and compares the upper limit value against the number of files obtained from the remote copy information T20.

When remote copy target files in excess of the prescribed value are accumulated in the logical volume 33, the first server 10 requests a second server 20 capable of using the logical volume 33 to read out a remote copy target file (S405).

The second server 20 respectively monitors whether or not an indication to check the remote copy has been inputted (S410), whether or not an access request has been received from the host 40 (S411), and whether or not a read-out of the remote copy target file has been requested by the first server 10 (S412).

In the remote copy check (S410), for example, a determination is made as to whether or not a check of the remote copy target file has been requested by the user or the program. Upon receiving the access request (S411), a determination is made as to whether or not various commands for accessing the logical volume 33 (write command, read command, test command) have been received. In the read-out request from the first server 10 (S412), a determination is made as to whether or not the first server 10 requested the read-out of the remote copy target file in S405.

When YES has been determined in any one of S410 through S412, the second server 20 queries the first server 10 for permission to use the logical volume 33, acquires the logical volume 33 lock, and mounts the logical volume 33 to the second server 20 (S413).

The second server 20 acquires the remote copy information T20 from the first server 10 (S414), and reads out the remote copy target file from the logical volume 33 (S415). The read-out file is stored in the DAS 25 inside the second server 20. The second server 20 notifies the first server 10 to the effect that the remote copy target file read-out has been completed, that is, to the effect that the remote copy process has been completed (S416).

This embodiment, which is configured thusly, also exhibits the same effects as the first embodiment. Furthermore, in this embodiment, in addition to when the logical volume 33 is accessed (S411), a remote copy target file can also be read out from the logical volume 33 when a check is requested (S410), and when a read-out has been requested from the first server 10 (S412). Therefore, it is possible to hold down on cases in which remote copy target files are placed in a state of being accumulated as-is inside the logical volume 33 for long periods of time.

Furthermore, the present invention is not limited to the respective embodiments described hereinabove. A person having ordinary skill in the art should be able to make various additions and changes without departing from the scope of the present invention.

1. A computer system, in which a first computer, a second computer and a shared storage device are communicably connected via a communication network, wherein
the shared storage device comprises at least one logical volume that is shared by the first computer and the second computer,
the first computer comprises a first storage device, and a first controller for controlling the input/output of data to/from the first storage device, and permission to use the shared storage device,
the second computer comprises a second storage device, and a second controller for controlling the input/output of data to/from the second storage device,
the first controller, upon receiving a remote copy request to remote copy data from the first storage device to the second storage device via the logical volume, transfers remote copy target data specified by the remote copy request from the first storage device and stores the data in the logical volume, and, stores location management information, which shows that the remote copy target data is stored in a prescribed location in the logical volume, in the first storage device, and
the second controller queries the first controller in accordance with an inputted access request for permission to use the logical volume, acquires the location management information from the first storage device, and transfers the remote copy target data stored in the logical volume to the second storage device from the logical volume.

2. The computer system according to claim 1, wherein the access request inputted to the second computer is at least any one of a request to read from the logical volume, a request to write to the logical volume, a request to check the logical volume, or a request to delete the data inside the logical volume.

3. The computer system according to claim 1, wherein, when the access request inputted to the second computer shows that remote copy is prohibited, the second controller does not transfer the remote copy target data from the logical volume to the second storage device.

4. The computer system according to claim 1, wherein the second controller, upon receiving permission from the first controller to use the logical volume, accesses the first storage device and determines whether or not the location management information is stored in the first storage device, and when the location management information is stored in the first storage device, transfers all the remote copy target data specified by the location management information from the logical volume to the second storage device.

5. The computer system according to claim 1, wherein the first storage device comprises a first memory device, and a first auxiliary storage device with a storage capacity that is larger than the first memory device, and
the location management information is stored in the first memory device.

6. The computer system according to claim 1, wherein the first controller comprises a cache function for temporarily storing data read out from the logical volume, and the cache function controls a temporary storage destination of the data in accordance with a type of the data read out from the logical volume.

7. The computer system according to claim 6, wherein, when the data stored in the logical volume is changed, the first controller destroys cache data corresponding to the data to be changed, and, when data stored in the logical volume is read out, stores cache data of the read-out data.

8. The computer system according to claim 7, wherein, when the cache data is created, the first controller creates and stores verification information comprising a location inside the logical volume of the data read out from the logical volume, and a mount point when mounting the data.

9. The computer system according to claim 6, wherein the first storage device comprises a first memory device with a relatively small storage capacity, and a first auxiliary storage device with a relatively larger storage capacity than the first memory device, and
the first controller temporarily stores data read out from the logical volume in the first memory device when the data has a relatively small data size, and stores data read out from the logical volume in the first auxiliary storage device when the data has a relatively large data size.

10. The computer system according to claim 6, wherein the first storage device comprises a first memory device with a relatively small storage capacity, and a first auxiliary storage device with a relatively larger storage capacity than the first memory device, and
the first controller:
(1) temporarily stores data read out from the logical volume in the first memory device when the data has a relatively small data size, and stores data read out from the logical volume in the first auxiliary storage device when the data has a relatively large data size;
(2) upon creating the cache data, creates and stores verification information comprising a location inside the logical volume of the data read out from the logical volume, and a mount point when mounting the data;
(3) when data stored in the logical volume is changed, destroys only cache data corresponding to the data to be changed, and stores the verification information as-is; and
(4) when data stored in the logical volume is read out, stores cache data of the read-out data.

11. The computer system according to claim 1, wherein the first controller stores in a wait queue a separate usage request issued while the logical volume is used, and when it becomes possible to use the logical volume, issues an indication to reboot the separate usage request stored in the wait queue.

12. The computer system according to claim 1, wherein the shared storage device is configured as a storage device that operates based on the iSCSI (Internet Small Computer System Interface).

13. A remote copy method for carrying out a remote copy from a first computer to a second computer by way of a shared storage device,
the shared storage device comprising at least one logical volume that is shared by the first computer and the second computer,
the remote copy method comprising the steps of:
the first computer receiving a remote copy request to remote copy data from a first storage device of the first computer to a second storage device via the logical volume;
the first computer transferring remote copy target data specified by the remote copy request from the first storage device and stores the data in the logical volume;
the first computer storing location management information, which shows that the remote copy target data is stored in a prescribed location in the logical volume, in the first computer;
the second computer receiving an access request related to the logical volume;
the second computer querying the first computer for permission to use the logical volume;
the first computer responding to a query from the second computer;
the second computer acquiring the location management information from the first computer upon obtaining permission to use the logical volume from the first computer; and
the second computer transferring all or a portion of the remote copy target data stored in the logical volume to the second storage device of the second computer from the logical volume.

14. A first computer, which is respectively connected to a second computer and a shared storage device via a communication network,
the shared storage device comprising at least one logical volume that is shared by the first computer and the second computer,
the first computer comprising:
a first storage device; and
a first controller for respectively controlling input/output of data to/from the first storage device, and the permission to use the shared storage device,
wherein the first controller, upon receiving a remote copy request to remote copy data from the first storage device to a second storage device of the second computer via the logical volume, transfers remote copy target data specified by the remote copy request from the first storage device and stores the data in the logical volume, and, stores location management information, which shows that the remote copy target data is stored in a prescribed location in the logical volume, in the first storage device, and
when the second computer queries for permission to use the logical volume, transfers the remote copy target data in the logical volume to the second storage device from the logical volume on the basis of the location management information.
